(19) United States
(12) Patent Application Publication
(10) Pub. No.: US 2004/0265629 A1
(43) Pub. Date: Dec. 30, 2004

(54) Organic luminescent compounds and methods of making and using same

(76) Inventors: Suning Wang, Kingston (CA); Wen-Li Jia, Kingston (CA)

Correspondence Address: Carol Miernicki Steeg, PARTEQ Innovations, Room 1625, Biosciences Complex, Queen's University at Kingston, Kingston, ON, K7L 3N6, CA

(21) Appl. No.: 10/825,689

(22) Filed: Apr. 16, 2004

Related U.S. Application Data
(60) Provisional application No. 60/463,336, filed on Apr. 17, 2003.

(30) Foreign Application Priority Data
Apr. 17, 2003 (CA) 2,425,817

(51) Int. Cl. C09K 11/06; H05B 33/14

(52) U.S. Cl. 428/690; 428/917; 252/301.16; 252/301.35; 313/504; 313/506; 136/263; 257/40; 546/255; 546/264; 546/304; 564/305; 564/433

(57) ABSTRACT

The invention provides organic compounds of the general structures (1A), (1B) and (1C)

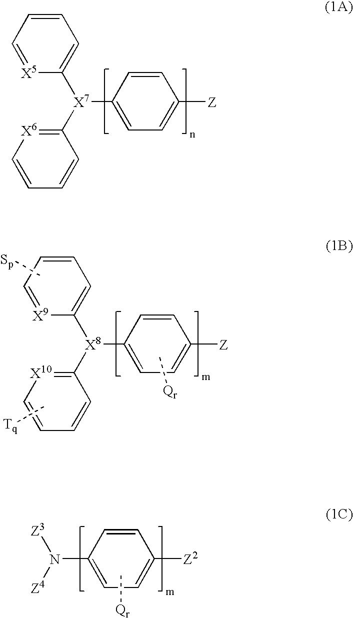

that are photoluminescent and electroluminescent, emitting intense blue light. The invention further provides methods of synthesizing such compounds, methods of producing photoluminescence and electroluminescence, methods of applying the compounds in thin films, and uses of the compounds of the invention in luminescent probes, electroluminescent displays and as pH probes and metal ion detectors.

This application claims the benefit of priority from U.S. Provisional Application Ser. No. 60/463,336, filed Apr. 17, 2003, which is herein incorporated by reference in its entirety.

### FIELD OF THE INVENTION

The invention relates to organic compounds having luminescent properties, and to methods of synthesizing and using such compounds. The invention more particularly relates to compounds having photoluminescent and/or electroluminescent properties, and to synthesis and uses of same. The invention also relates to compounds having photo-receptor properties due to their ability to separate charges. The invention also relates to compounds having photon harvesting properties. The invention also relates to compounds that visibly display detection of metal ions or acid. The invention further relates to compounds that can provide a molecular switch.

### BACKGROUND OF THE INVENTION

Production of devices based on electroluminescent display is a rapidly growing, billion dollar industry. Bright and efficient organic light-emitting diode (OLED) devices and electroluminescent (EL) devices have attracted considerable interest due to their potential application for flat panel displays (e.g., television and computer monitors). OLED based displays offer advantages over the traditional liquid crystal displays, such as: wide viewing angle, fast response, lower power consumption, and lower cost. However, several challenges still must be addressed before OLEDs become truly affordable and attractive replacements for liquid crystal based displays. To realize full color display applications, it is essential to have the three fundamental colors of red, green, and blue provided by emitters with sufficient color purity and sufficiently high emission efficiency.

In general, when a potential is applied across an OLED, holes are said to be injected from an anode into a hole transporting layer (HTL) while electrons are injected from a cathode into an electron transporting layer (ETL). The holes and electrons migrate to an ETL/HTL interface. Materials for these transporting layers are chosen so that holes are preferentially transported by the HTL, and electrons are preferentially transported by the ETL. At the ETL/HTL interface, the holes and electrons recombine to give excited molecules which radiatively relax, producing an EL emission that can range from blue to near-infrared (Koene, 1998).

In providing one of the key color components for electroluminescent display devices, blue luminescent compounds are among the most sought-after materials by industry around the world. Two alternative ways in which blue luminescence can be achieved are: (i) providing a molecule which emits blue color (emitter), and (ii) doping an emitter such that the combination yields blue luminescence. Conveniently, the emitter can be an inorganic metal ion such as, for example, lanthanide, which emits blue light via d to f or f to f electronic transitions, or an organic molecule which has conjugated π bonds and emits blue light via π to π or π to n electronic transitions.

A common problem with blue emitters is their lack of long term stability in OLEDs. OLEDs generally suffer from a gradual intensity decrease of the blue hue, which results in gradual deterioration of the color purity of the display, and ultimately failure of the device. Television and computer monitors must perform consistently for at least five years in order to be commercially feasible. Even this modest expectation is a big challenge for currently available OLEDs.

There are several blue luminescent inorganic coordination compounds known (U.S. Pat. No. 6,500,569, U.S. Pat. No. 6,312,835, Yang, 2001, Jia et al., 2003); however, in some cases, due to a propensity for oxidation and/or hydrolysis reactions, such complexes are not very stable in solution. One family of known inorganic blue emitters, lanthanide ions, have low emission efficiency and require the use of a host (generally an inorganic salt), which makes it difficult to process them into thin films.

Thus, blue luminescent materials that are organic in nature are desirable due to their increased stability, solubility and ability to form thin films. A number of organic blue emitters are known to date (Shirota, 2000, Yang, 2001, Wu et al., 2001, and Liu et al., 2000). Many of these have poor luminescence efficiency and poor stability. Some are luminescent polymers that are difficult to apply in films using chemical vapor deposition (CVD) or vacuum deposition, processes known to produce superior films for electroluminescent displays. Even the best blue emitters currently available do not have the long term stability desired for commercial devices.

The limitations discussed above could restrict the market for OLED products, despite their many superior aspects as compared with liquid crystal displays. Therefore, in order for OLEDs to become truly feasible, there is a need for stable, organic emitters.

### BRIEF STATEMENT OF THE INVENTION

In a first aspect, the invention provides a compound having a general formula (1A):

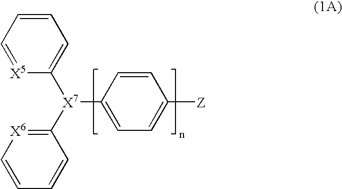

where X⁵, X⁶ and X⁷ are each independently selected from the group consisting of carbon and nitrogen;

n is a number from 0-2;

Z is a substituted or unsubstituted aryl moiety selected from the group consisting of phenyl, biphenyl, naphthyl, anthryl, phenanthryl, pyrenyl, pyridyl, bipyridyl, indyl, and quinolinyl; and

wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

In some embodiments, X⁵, X⁶ and X⁷ may be each independently selected from the group consisting of a substituted carbon, an unsubstituted carbon and an unsubstituted nitrogen. In some embodiments, at least one of X⁵, X⁶ and X⁷ is nitrogen. In some embodiments, X⁵, X⁶ and X⁷ are nitrogen.

In a second aspect, the invention provides a compound having a general formula (1 B):

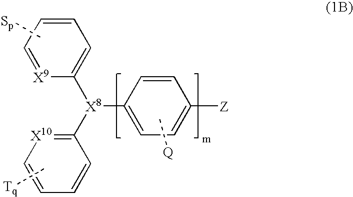

where X⁸, X⁹ and X¹⁰ are each independently selected from the group consisting of a substituted or unsubstituted carbon, an unsubstituted nitrogen and a substituted or unsubstituted silicon;

m is a number from 0-10;

Q, S and T are the same or different and are selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic;

p and q are the same or different and are a number between 0-5;

r is a number between 0-4;

Z is a substituted or unsubstituted aryl moiety selected from the group consisting of phenyl, biphenyl, naphthyl, anthryl, phenanthryl, pyrenyl, pyridyl, bipyridyl, indyl, and quinolinyl;

wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

In some embodiments, X⁸ is selected from the group consisting of a substituted or unsubstituted carbon, an unsubstituted nitrogen and a substituted or unsubstituted silicon; X⁹ and X¹⁰ are each independently selected from the group consisting of a substituted or unsubstituted carbon and an unsubstituted nitrogen; and m is a number from 0 to 4. In some embodiments, X⁸ is nitrogen; X⁹ and X¹⁰ are each independently selected from the group consisting of a substituted or unsubstituted carbon and an unsubstituted nitrogen; and m is a number from 1 to 4.

In a third aspect, the invention provides a compound having a general formula (1C):

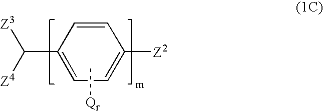

where Z², Z³ and Z⁴ are each independently a substituted or unsubstituted aryl moiety selected from the group consisting of phenyl, biphenyl, naphthyl, anthryl, phenanthryl, pyrenyl, pyridyl, bipyridyl, indyl, and quinolinyl;

m is a number from 0-10;

Q is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic;

r is a number between 0 and 4;

wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

In another aspect, the invention provides a photoluminescent or electroluminescent compound having a formula selected from the group consisting of 1-pyrenyl-2,2′-dipyridylamine (2), 4-(1-pyrenyl)phenyl-2,2′-dipyridylamine (3), 4-[4′-(1-pyrenyl)biphenyl]-2,2′-dipyridylamine (4), 4-(1-pyrenyl)biphenyl-2,2′-diphenylamine (5) and QNPB (6).

Compounds of the invention may be photoluminescent and/or electroluminescent. Compounds of the invention may be hole transporters.

In further aspect, the invention provides a method of synthesizing a compound of general formula (1A), comprising a step selected from the group consisting of:

1-bromopyrenyl+2,2′-dipyridylamine+CuI+K₃PO₄+1,2-transdiaminocyclohexane+1,4-dioxane [symbol] 1-pyrenyl-2,2′-dipyridylamine (2);

Pd(PPh₃)₄₊₁-bromopyrene+p-(2,2′-dipyridylamino)phenyl boronic acid [symbol] 4-(1-pyrenyl)phenyl-2,2′-dipyridylamine(3);

Pd(PPh₃)₄₊₁-bromopyrene+p-(2,2′-dipyridylamino)biphenylboronic acid [symbol] 4-[4′-(1-pyrenyl)biphenyl]-2,2′-dipyridylamine(4);

4-iodo-4′-diphenylaminobiphenyl+B(OCH₃)₃+N-BuLi [symbol] 4-(1-pyrenyl)biphenyl-2,2′-diphenylamine (5); and

p-N-(1-naphthyl)-N-phenylamino-biphenyl-iodide+B(i-OPr)₃+N-BuLi [symbol] p-N-(1-naphthyl)-N-phenylamino-biphenyl-B(OH)₂₊₅-bromo-8-methoxyquinoline+Pd(OAc)₂+PPh₃+Na₂CO₃ [symbol] QNPB (6).

In further aspect, the invention provides a method of synthesizing a compound of general formula (1 B), comprising a step selected from the group consisting of:

1-bromopyrenyl+2,2′-dipyridylamine+CuI+K₃PO_{4+1,2}-transdiaminocyclohexane+1,4-dioxane [symbol] 1-pyrenyl-2,2′-dipyridylamine (2);

Pd(PPh₃)₄₊₁-bromopyrene+p-(2,2′-dipyridylamino)phenyl boronic acid [symbol] 4-(1-pyrenyl)phenyl-2,2′-dipyridylamine(3);

Pd(PPh₃)₄₊₁-bromopyrene+p-(2,2′-dipyridylamino)biphenylboronic acid [symbol] 4-[4′-(1-pyrenyl)biphenyl]-2,2′-dipyridylamine(4); and

4-iodo-4′-diphenylaminobiphenyl+B(OCH₃)₃+N-BuLi [symbol] 4-(1-pyrenyl)biphenyl-2,2′-diphenylamine (5).

In further aspect, the invention provides a method of synthesizing a compound of general formula (1C), comprising a step selected from the group consisting of:

p-N-(1-naphthyl)-N-phenylamino-biphenyl-iodide+B(i-OPr)₃+N-BuLi [symbol] p-N-(1-naphthyl)-N-phenylamino-biphenyl-B(OH)₂₊₅-bromo-8-methoxyquinoline+Pd(OAc)₂+PPh₃+Na₂CO₃ [symbol] QNPB (6).

In further aspects, the invention provides compositions comprising a compound of the invention, an organic polymer and a solvent.

In still further aspects, the invention provides a photoluminescent product or an electroluminescent product comprising a compound of the invention. The product may be a flat panel display device. The product may be a luminescent probe.

In another aspect, the invention provides a method of producing electroluminescence, comprising the steps of: providing an electroluminescent compound of the invention and applying a voltage across said compound so that said compound electroluminesces.

In other aspects, the invention provides electroluminescent devices for use with an applied voltage.

A first such device comprises: a first electrode, an emitter which is an electroluminescent compound of the invention, and a second, transparent electrode, wherein voltage is applied to the two electrodes to produce an electric field across the emitter so that the emitter electroluminesces.

A second such device comprises: a first electrode, a second, transparent electrode, an electron transport layer adjacent the first electrode, a hole transport layer adjacent the second electrode, and an emitter which is an electroluminescent compound of the invention interposed between the electron transport layer and the hole transport layer, wherein voltage is applied to the two electrodes to produce an electric field across the emitter so that the emitter electroluminesces.

A third such device comprises: a first electrode, a second, transparent electrode, a layer which is both an emitter and an electron transporter which is an electroluminescent compound of the invention and which is located adjacent the first electrode, and a hole transport layer which is interposed between the emitter and electron transport layer and the second electrode, wherein voltage is applied to the two electrodes to produce an electric field so that the emitter electroluminesces.

A fourth such device comprises: a first electrode, a second, transparent electrode, a layer which is all of an emitter, an electron transporter and a hole transporter which is an electroluminescent compound of the invention and which is interposed between the first and the second electrode, wherein voltage is applied to the two electrodes to produce an electric field so that the emitter electroluminesces.

A fifth such device comprises: a first electrode, a second, transparent electrode, an electron transport layer which is a compound of the invention and which is located adjacent the first electrode, a hole transport layer adjacent the second electrode, and an emitter which is interposed between the electron transport layer and the hole transport layer, wherein voltage is applied to the two electrodes to produce an electric field so that the emitter electroluminesces.

A sixth such device comprises: a first electrode, a second, transparent electrode, an electron transport layer which is located adjacent the first electrode, a hole transport layer which is a compound of the invention and which is located adjacent the second electrode, and an emitter which is interposed between the electron transport layer and the hole transport layer, wherein voltage is applied to the two electrodes to produce an electric field so that the emitter electroluminesces.

A seventh such device comprises: a first electrode, a second, transparent electrode, a layer which is both an electron transporter and an emitter which is located adjacent the first electrode, and a hole transport layer which is a compound of the invention and which is interposed between the electron transport layer and the second electrode, wherein voltage is applied to the two electrodes to produce an electric field so that the emitter electroluminesces.

An eighth such device comprises: a first electrode, a second, transparent electrode, an electron transport layer which is located adjacent the first electrode, and a layer which is both an emitter and a hole transporter which is a compound of the invention and which is interposed between the electron transport layer and the second electrode, wherein voltage is applied to the two electrodes to produce an electric field so that the emitter electroluminesces.

In another aspect, the invention provides a method of detecting metal ions, comprising the steps of: providing a photoluminescent compound of the invention, and detecting photoluminescence of said compound, wherein contact with a metal ion quenches said photoluminescence of said compound. The metal ions may be selected from the group consisting of Zn²⁺, Cu²⁺, Ni²⁺, Cd²⁺, Hg²⁺ and Ag⁺.

In another aspect, the invention provides a method of detecting acid, comprising the steps of: providing a photoluminescent compound of the invention, and detecting photoluminescence of said compound, wherein protonation of said compound changes the state of said compound's photoluminescence.

In another aspect, the invention provides a method of harvesting photons, comprising the steps of: providing a compound of the invention, and providing light such that photons strike said compound and charge separation occurs in said compound. In some embodiments, the separated charges may recombine and photons be released. In some embodiments, the separated charges may migrate to respective electrodes to produce a potential difference.

In another aspect, the invention provides a method of separating charges, comprising the steps of: providing a compound of the invention, and providing light such that photons strike said compound and charge separation occurs in said compound. In some embodiments, the separated charges may recombine and photons be released. In some embodiments, the separated charges may migrate to respective electrodes to produce a potential difference.

In other aspects, the invention provides a photocopier, a photovoltaic device, a photoreceptor, a solar cell and a semiconductor employing the afore-mentioned methods of harvesting photons and/or separating charges.

In another aspect, the invention provides a molecular switch comprising a compound of the invention that is capable of existing in more than one luminescent state, wherein acid, base, and/or incident light produces a change in the luminescent state of said compound. The invention further provides a circuit comprising such a molecular switch.

### BRIEF DESCRIPTION OF THE DRAWINGS

For a better understanding of the present invention and to show more clearly how it may be carried into effect, reference will now be made by way of example to the accompanying drawings, which illustrate aspects and features according to preferred embodiments of the present invention, and in which:

FIG. 1 shows a preferred embodiment of a three layer electroluminescent (EL) display device according to the invention.

FIG. 2 shows the excitation (lower wavelength) and emission (higher wavelength) photoluminescence spectra of 1-pyrenyl-2,2′-dipyridylamine (2) as a solid.

FIG. 3 shows the excitation (lower wavelength) and emission (higher wavelength) photoluminescence spectra of 1-pyrenyl-2,2′-dipyridylamine (2) in a CH₂Cl₂ solution at a concentration of 2.55×10⁻⁶ M at 298K.

FIG. 4 shows the excitation (lower wavelength) and emission (higher wavelength) photoluminescence spectra of 4-(1-pyrenyl)phenyl-2,2′-dipyridylamine (3) as a solid.

FIG. 5 shows the excitation (lower wavelength) and emission (higher wavelength) photoluminescence spectra of 4-(1-pyrenyl)phenyl-2,2′-dipyridylamine (3) in a CH₂Cl₂ solution at a concentration of 2.55×10⁻⁶ M at 298K.

FIG. 6 shows the excitation (lower wavelength) and emission (higher wavelength) photoluminescence spectra of 4-[4(1-pyrenyl)biphenyl]-2,2′-dipyridylamine (4) as a solid.

FIG. 7 shows the excitation (lower wavelength) and emission (higher wavelength) photoluminescence spectra of 4-[4′-(1-pyrenyl)biphenyl]-2,2′-dipyridylamine (4) in a CH₂Cl₂ solution at a concentration of 2.55×10⁻⁶ M at 298K.

FIG. 8 shows an electroluminescence spectrum produced by compound 4-(1-pyrenyl)phenyl-2,2′-dipyridylamine (3) in a two layer EL device described in Example 6.

FIG. 9 shows the crystal structure of compound (2).

FIG. 10 shows the crystal structure of compound (3).

FIG. 11 shows the crystal structure of compound (4).

FIG. 12 shows the (-) photoluminescence (PL) spectrum of compound (4) and the (.-.-.-) electroluminescence (EL) spectrum of compound (4) produced by a solid-state film at 298K.

FIG. 13 shows the dependence of Luminance (L) and Current Density (J) on Voltage (V) of a film of compound (4) in a two layer EL device of the following configuration: ITO/NPB (40 nm)/compound(4) (40 nm)/LiF (1 nm)/Al, where NPB is the hole transport layer, compound (4) is both the emitter and electron transport layer and LiF is added to improve contact between the electron transport layer and the cathode.

FIG. 14 shows the excitation (lower wavelength) and the emission (higher wavelength) spectra of compound (5) as a solid-state film (-) at 298K and as a CH₂Cl₂ solution (□) at a concentration of 10⁻⁵ M at 298K.

FIG. 15A is a cyclic voltametry diagram starting with the reduction of compound (5) in a mixture of CH₂Cl₂ and CH₃CN. This figure provides information about the Lowest Unoccupied Molecular Orbital (LUMO) of the molecule and indicates promising electron transport properties of the molecule.

FIG. 15B is a cyclic voltametry diagram starting with the oxidation of compound (5) in a mixture of CH₂Cl₂ and CH₃CN. This figure provides information about the Highest Occupied Molecular Orbital (HOMO) of the molecule and indicates promising hole transport properties of the molecule.

FIG. 16 shows the dependence of Luminance (L) and Current (I) on Voltage (V) of a single layer EL device of compound (4) prepared with the following configuration: ITO/compound (4) (60 nm)/LiF(0.5 nm)/Al(140 nm), where compound (4) is the hole transport layer, emitter and electron transport layer and LiF is added to improve contact between the film and the cathode.

FIG. 17A shows the dependence of Current Density (J) on Voltage (V) of a film of compound (6) in a single layer EL device of the following configuration: ITO/compound (6) (90 nm)/LiF (0.5 nm)/Al, where compound (6) is all of electron transport layer, emitter and hole transport layer and LiF is added to improve contact between the film and the cathode.

FIG. 17B shows the dependence of Luminance (L) on Voltage (V) of a film of compound (6) in a single layer EL device of the following configuration: ITO/compound (6) (90 nm)/LiF (0.5 nm)/Al, where compound (6) is all of electron transport layer, emitter and hole transport layer and LiF is added to improve contact between the film and the cathode.

FIG. 18 shows the (-) photoluminescence spectrum of compound (6) and the (.-.-.-) electroluminescence spectrum of compound (6) produced by a single layer EL device of the following configuration: ITO/compound (6) (90 nm)/LiF (0.5 nm)/Al, where compound (6) is all of electron transport layer, emitter and hole transport layer and LiF is added to improve contact between the film and the cathode.

FIG. 19A shows the dependence of Current Density (J) on Voltage (V) of a film of compound (6) in a double layer EL device of the following configuration: ITO/compound (6) (30, 60, 90, 120 nm)/Alq₃ (40 nm)/LiF (0.5 nm)/Al, where compound (6) is the hole transport layer and Alq₃ is both emitter and electron transport layer and LiF is added to improve contact between the film and the cathode.

FIG. 19B shows the dependence of Luminance (L) on Voltage (V) of a film of compound (6) in a double layer EL device of the following configuration: ITO/compound (6) (30, 60, 90, 120 nm)/Alq₃ (40 nm)/LiF (0.5 nm)/Al, where compound (6) is the hole transport layer and Alq₃ is both emitter and electron transport layer and LiF is added to improve contact between the film and the cathode.

FIG. 20 shows the crystal structure of (6).

FIG. 21 is a cyclic voltammetry diagram starting with the oxidation of compound (6) in CH₂Cl₂. This figure provides information about the Highest Occupied Molecular Orbital (HOMO) of the molecule and indicates promising hole transport properties of the molecule.

### DETAILED DESCRIPTION OF THE INVENTION

In a first aspect of the invention, a stable organic compound of the general formula (1A) is provided:

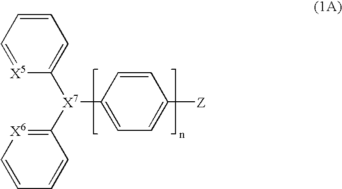

where X⁵, X⁶ and X⁷ are each independently selected from the group consisting of carbon and nitrogen;

n is a number from 0-2;

Z is a substituted or unsubstituted aryl moiety selected from the group consisting of phenyl, biphenyl, naphthyl, anthryl, phenanthryl, pyrenyl, pyridyl, bipyridyl, indyl, and quinolinyl (preferred substituent examples 1a-1m are pictured below); and

wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

Preferably a compound of general formula (1A) exhibits intense luminescence, which may be photoluminescence and/or electroluminescence.

In preferred embodiments of compounds of the general formula (1A), X⁵, X⁶ and X⁷ are each independently a substituted or unsubstituted carbon or an unsubstituted nitrogen. In some embodiments, one or two of X⁵, X⁶ and X⁷ are nitrogen. In a preferred embodiment, X⁵, X⁶ and X⁷ are all nitrogen. A synthetic scheme depicting the preparation of such compounds is pictured in Schemes 1 and 2; working examples of detailed synthetic procedures are provided in Examples 1-4.

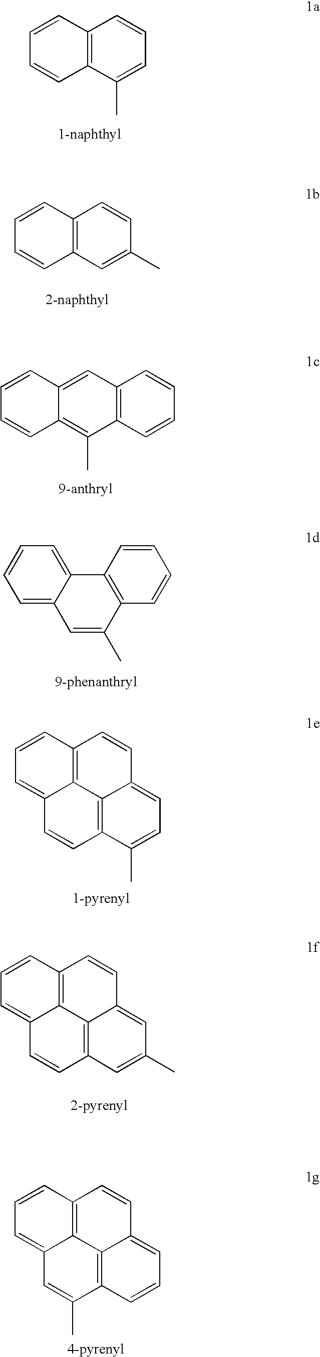

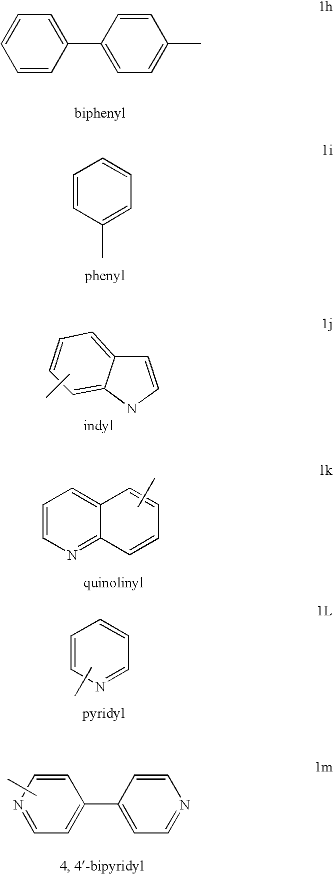

In another aspect of the invention, a stable organic compound of the general formula (1B) is provided:

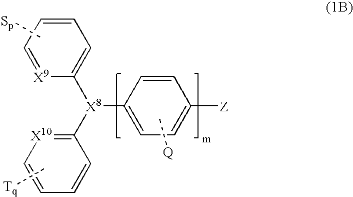

where X⁸, X⁹ and X¹⁰ are each independently selected from the group consisting of a substituted or unsubstituted carbon, an unsubstituted nitrogen and a substituted or unsubstituted silicon;

m is a number from 0-10, preferably 1-4, most preferably 2;

Q, S and T are the same or different and are selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic;

p and q are the same or different and are a number between 0-5;

r is a number between 0-4;

Z is a substituted or unsubstituted aryl moiety selected from the group consisting of phenyl, biphenyl, naphthyl, anthryl, phenanthryl, pyrenyl, pyridyl, bipyridyl, indyl, and quinolinyl (preferred substituent examples 1a-1m are pictured above); and

wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

Preferably a compound of general formula (1B) exhibits intense luminescence, which may be photoluminescence and/or electroluminescence.

A preferred embodiment of the invention, particularly for hole transporting properties, is described by the general formula (1B), where

X⁸ is nitrogen;

X⁹ and X¹⁰ are each independently selected from the group consisting of a substituted or unsubstituted carbon and an unsubstituted nitrogen; and

m is a number from 1-4.

Another preferred embodiment of the invention is described by the general formula (1B), where

X⁸ is selected from the group consisting of a substituted or unsubstituted carbon, an unsubstituted nitrogen and a substituted or unsubstituted silicon;

X⁹ and X¹⁰ are each independently selected from the group consisting of a substituted or unsubstituted carbon and an unsubstituted nitrogen; and

m is a number from 0 to 4.

In another aspect of the invention, a stable organic compound of the general formula (1 C) is provided:

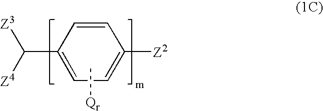

where

m is a number from 0-10, preferably 1-4, most preferably 2;

Q is selected from the group consisting of aryl group, an alkoxy group, a hydroxy group, a halo group, an amino group, a nitro group, a nitrile group, —CF₃ and an aliphatic group having 1-24 carbon atoms which may be straight, branched or cyclic;

r is a number between 0-4;

Z², Z³ and Z⁴ may be the same or different substituted or unsubstituted aryl moiety selected from the group consisting of phenyl, biphenyl, naphthyl, anthryl, phenanthryl, pyrenyl, pyridyl, bipyridyl, indyl, and quinolinyl (preferred substituent examples 1a-1 m are pictured above); and

wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

Preferably a compound of general formula (1C) exhibits intense luminescence, which may be photoluminescence and/or electroluminescence.

In a preferred embodiment of compounds of the general formula (1 C), Z³ is phenyl, Z⁴ is napthyl, m is 2 and Z² is substituted quinolyl. A synthetic scheme depicting the preparation of such compound is pictured in Scheme 3; a working example of detailed synthetic procedures is provided in Example 5.

As used herein “aliphatic” includes alkyl, alkenyl and alkynyl. An aliphatic group may be substituted or unsubstituted. It may be straight chain, branched chain or cyclic.

As used herein “aryl” includes heteroaryl and may be substituted or unsubstituted.

Preferred aryl groups for Q, S, and T are Z.

As used herein “unsubstituted” refers to any open valence of an atom being occupied by hydrogen.

As used herein “substituted” refers to the structure having one or more substituents.

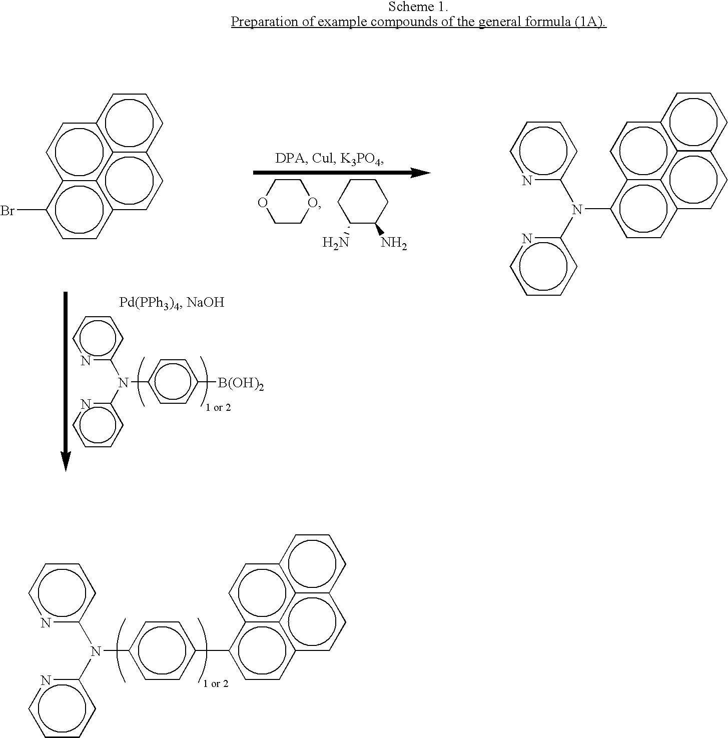

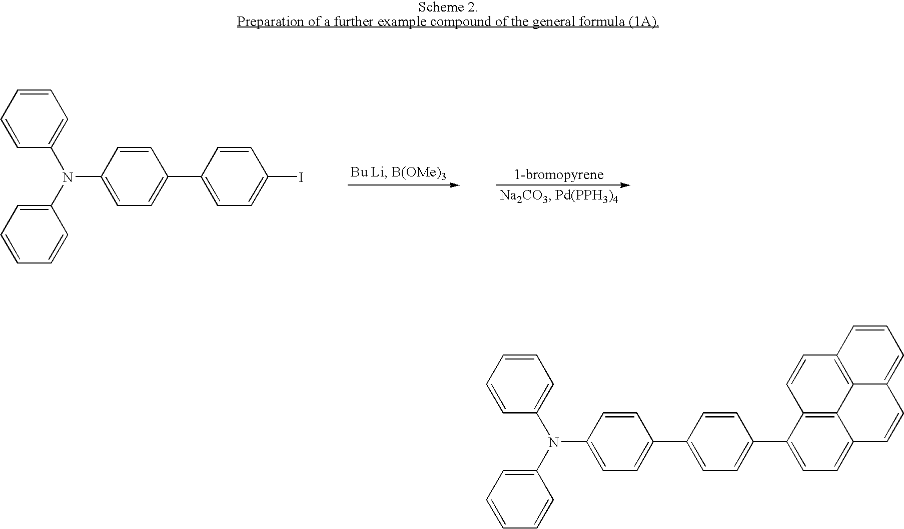

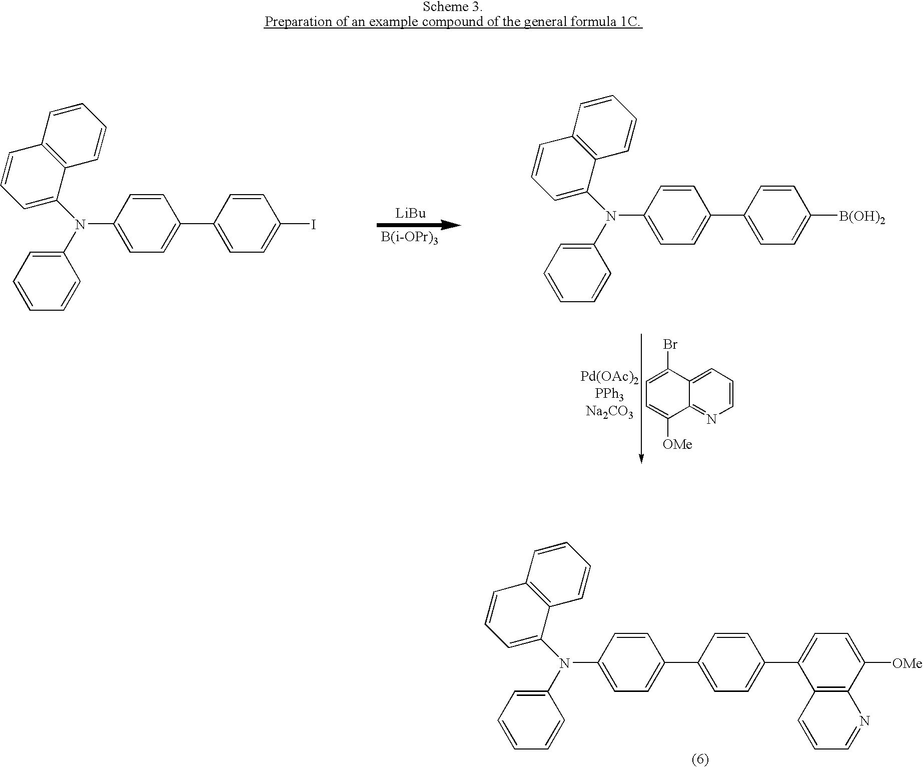

Thus, the invention provides, for example, compounds 1-pyrenyl-2,2′-dipyridylamine (2), 4-(1-pyrenyl)phenyl-2,2′-dipyridylamine (3), 4-[4′-(1-pyrenyl)biphenyl]-2,2′-dipyridylamine (4), 4-(1-pyrenyl)biphenyl-2,2′-diphenylamine (5), and QNPB (6) which have the following structures:

1-pyrenyl-2,2′-dipyridylamine (2)

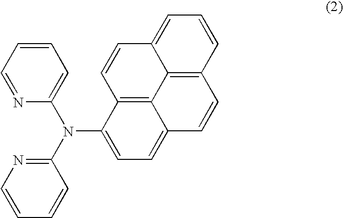

4-(1-pyrenyl)phenyl-2,2′-dipyridylamine (3)

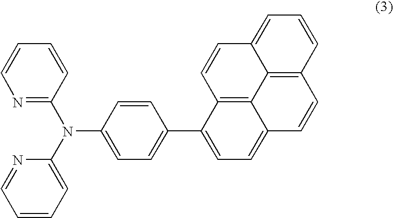

4-[4′-(1-pyrenyl)biphenyl]-2,2′-dipyridylamine (4)

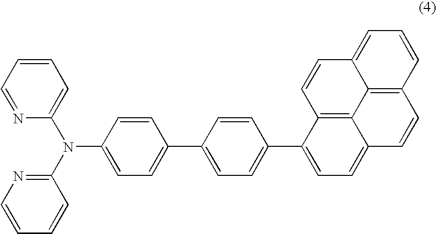

4-(1-pyrenyl)biphenyl-2,2′-diphenylamine (5)

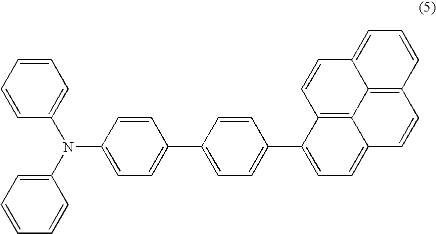

4-(1-naphthylphenylamino)-4′-(5-(8-methoxyquinolinyl))biphenyl (QNPB) (6)

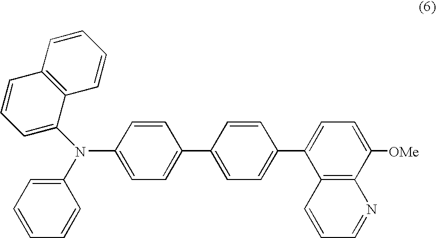

(Note that this same substituent, 2,2′-dipyridylamine (dpa), is called deprotonated di-2-pyridylamine in U.S. Pat. No. 6,500,569 and No. 6,312,835 by some of the present inventors.)

The invention provides compounds that are photoluminescent and, in at least some embodiments of the invention, electroluminescent; they can produce intense light.

The invention also provides a method of producing photoluminescence comprising the steps of: providing a photoluminescent compound of the invention having a formula as set out above; and irradiating said photoluminescent compound with radiation of a wavelength suitable for exciting the compound to photoluminescence.

The invention further provides a method of producing electroluminescence comprising the steps of: providing an electroluminescent compound of the invention having a formula as set out above; and applying a voltage across said electroluminescent compound.

The invention further provides an electroluminescent device for use with an applied voltage, comprising: a first electrode, an emitter (e.g., phosphor) which is an electroluminescent compound of the invention, and a second, transparent electrode, wherein a voltage is applied between the two electrodes to produce an electric field across the emitter. The emitter consequently electroluminesces. In some embodiments of the invention, the device includes one or more charge transport layers interposed between the emitter and one or both of the electrodes.

For example, spacing of a preferred embodiment of the device, called for the purposes of the present specification a “three layer EL device”, is: first electrode, first charge transport layer, emitter, second charge transport layer, and second, transparent electrode.

In certain embodiments of the invention, the device includes one or more compounds of the invention acting as one or more charge transport layers and/or emitter(s) interposed between the electrodes.

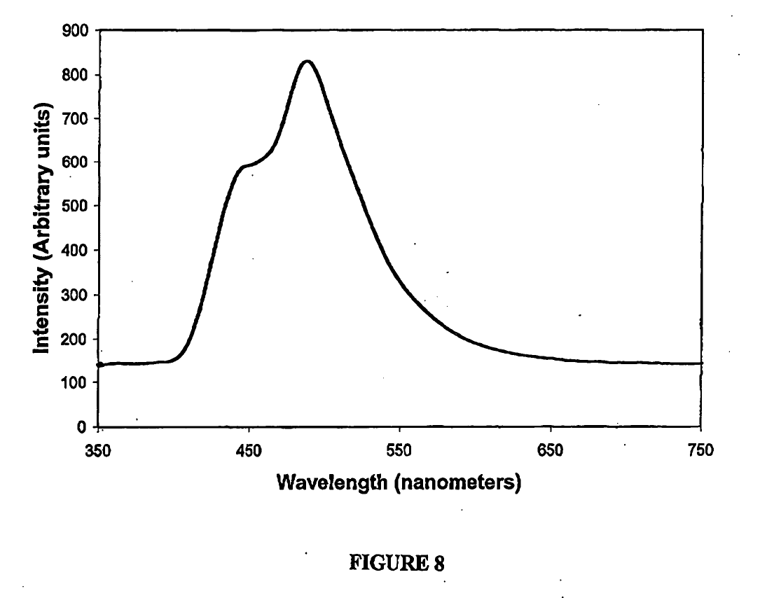

In one embodiment of the invention, called for the purposes of the present specification a “two layer EL device”, the spacing is: first electrode, charge transport layer, emitter/second charge transport layer, and second electrode. A working example of a two layer EL device is described in Example 6, referring to FIG. 8. Here, compound 4-(1-pyrenyl)phenyl-2,2′-dipyridylamine (3) acted as both an emitter and a charge (electron) transport layer.

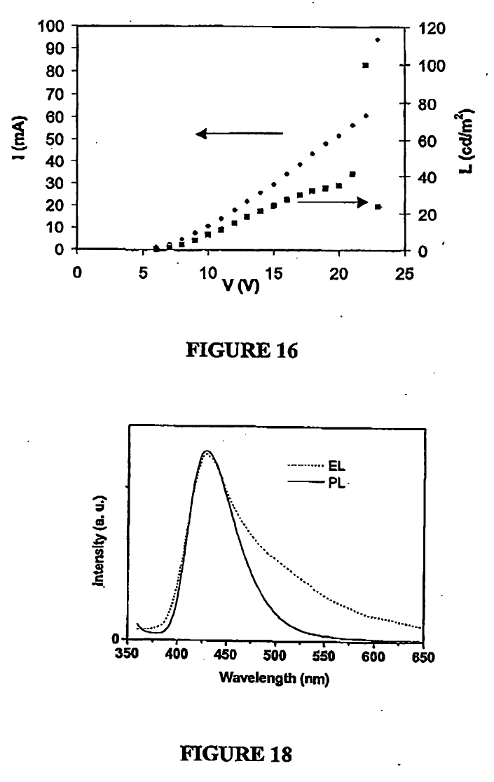

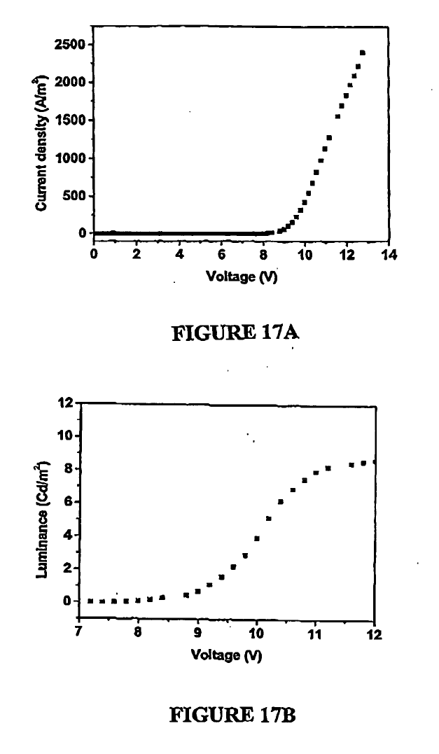

In another embodiment of the invention, called for the purposes of the present specification a “one layer EL device”, the spacing is: first electrode, first charge transport layer/emitter/second charge transport layer, second electrode. A working example of a one layer EL device is described in Example 7, and luminance and current produced are shown graphically in FIG. 16. Similarly, the luminance and current density for a single layer EL device of compound (6) are shown graphically in FIGS. 17A and 17B.

An advantage of preferred compounds of the invention is that they are highly soluble in common organic solvents such as toluene, diethyl ether, tetrahydrofuran (THF), and dichloromethane. This permits the compounds to be blended easily and conveniently with organic polymers. The role of the organic polymer in such a mixture is at least two-fold: First, a polymer can provide protection for the compound from air degradation. Second, a polymer host matrix permits the use of a spin-coating or dip-coating process as an alternative way to make films. Although spin-coating and dip-coating processes may not produce as high quality films as those produced by chemical vapor deposition or vacuum deposition, they are often much faster and more economical.

Accordingly, the invention further provides methods of applying compounds as described above to a surface. These methods include solvent cast from solution, electrochemical deposition, vacuum vapor deposition, chemical vapor deposition, spin coating and dip coating.

The compounds may be applied alone or with a carrier. In some embodiments of the invention, they are applied in a composition including an organic polymer. Such compositions are also encompassed by the invention.

As an example of this application, compounds of the invention are expected to form a clear transparent solution with the weakly-luminescent polymer poly(N-vinylcarbazole) (PVK) in CH₂Cl₂/C₆H₅Cl. This can be converted to a transparent film by evaporating the toluene solvent via either a dip-coating or spin-coating process. Films obtained in this way are stable. Certain polymers such as, for example, PVK, are expected to further enhance the luminescence of an emitter in the film.

The invention provides a method of producing electroluminescence comprising the steps of: providing an electroluminescent compound of the invention having the general formula (1A), (1B) or (1C) as set out above; and applying a voltage across said electroluminescent compound so that the compound electroluminesces.

According to the invention, electroluminescent devices for use with an applied voltage are provided. In general, such a device has a first electrode, an emitter which is an electroluminescent compound of the invention, and a second, transparent electrode, wherein a voltage is applied between the two electrodes to produce an electric field across the emitter of sufficient strength to cause the emitter to electroluminesce. Preferably, the first electrode is of a metal, such as, for example, aluminum, which reflects light emitted by the compound; whereas the second, transparent electrode permits passage of emitted light therethrough. The transparent electrode is preferably of indium tin oxide (ITO) glass or an equivalent known in the art. Here, the first electrode is the cathode and the second electrode is the anode.

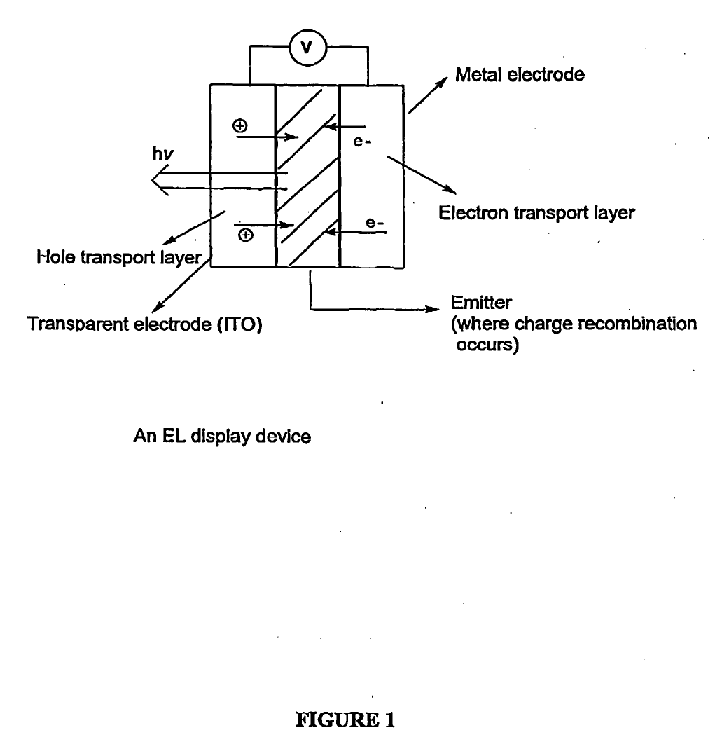

Referring to FIG. 1, a preferred embodiment of an electroluminescent device of the invention is shown. The emitter is interposed between an electron transport layer (e.g., tris-(8-hydroxyquinoline)aluminum (Alq₃) or 2-(biphenyl-4-yl)-5-(4-tert-butyl phenyl)-1,3,4-oxadiazole (PBD)) adjacent the first metal electrode and a hole transport layer (e.g., N,N′-di-1-naphthyl-N,N′-diphenylbenzidiine (NPB)) adjacent the second, transparent electrode. The choice of the materials employed as charge transport layers will depend upon the specific properties of the particular emitter employed. The hole transport layer or the electron transport layer may also function as a supporting layer. The device is connected to a voltage source such that an electric field of sufficient strength is applied across the emitter. Light, preferably blue light, consequently emitted from the compound of the invention passes through the transparent electrode. Some emitters may additionally function as an electron transport material and/or as a hole transport material in the device. Although some of the compounds of the invention may act in all three capacities, the best efficiency may be obtained by limiting the compound's role to one or two. Furthermore, a compound of the invention may act as a charge transport layer for another emitter which may or may not also be a compound of the invention.

In some embodiments of the invention, the device includes one or more charge transport layers interposed between the emitter and one or both of the electrodes. Such charge transport layer(s) are employed in prior art systems with inorganic salt emitters to reduce the voltage drop across the emitter. In a first example of such a device, layers are arranged in a sandwich in the following order: first electrode, charge transport layer, emitter, second charge transport layer, and second, transparent electrode. In a preferred embodiment of this type, a substrate of glass, quartz or the like is employed. A reflective metal layer (corresponding to the first electrode) is deposited on one side of the substrate, and an insulating charge transport layer is deposited on the other side. The emitter layer which is a compound of the invention is deposited on the charge transport layer, preferably by vacuum vapor deposition, though other methods may be equally effective. A transparent conducting electrode (e.g., ITO) is then deposited on the emitter layer.

An effective voltage is applied to produce electroluminescence of the emitter.

In a second example of an EL device of the invention, a second charge transport layer is employed, and the sandwich layers are arranged in the following order: first electrode, first charge transport layer, emitter, second charge transport layer and second, transparent electrode.

Electroluminescent devices of the invention may include one or more of the blue-emitting compounds described herein. In some embodiments of the invention, an electroluminescent device such as a flat panel display device may include not only a blue-emitting phosphor as described herein, but may be a multiple-color display device including one or more other phosphors. The other phosphors may emit in other light ranges, e.g., red, green, and/or be “stacked” relative to each other. Convenient materials, structures and uses of electroluminescent display devices are described in Rack et al., 1996.

For photoluminescence, the compounds absorb energy from ultraviolet radiation and emit visible light near the ultraviolet end of the visible spectrum e.g., in the blue region. For electroluminescence, the absorbed energy is from an applied electric field. It is expected that the luminescence of compounds of the invention can be readily quenched by the addition of acid or metal cations such as Zn²⁺, Cu²⁺, Ni²⁺, Cd²⁺ Hg²⁺, Ag⁺ and H⁺ (Pang et al., 2001, Yang et al., 2001).

The invention further provides methods employing compounds of the invention to harvest photons, and corresponding devices for such use. Spectroscopic studies have demonstrated that compounds of the invention have high efficiency to harvest photons and produce highly polarized electronic transitions. In general, when such compounds are excited by light, a charge separation occurs within the molecule; a first portion of the molecule has a negative charge and a second portion has a positive charge. Thus the first portion acts as an electron donor and the second portion as an electron acceptor. If recombination of the charge separation occurs, a photon is produced and luminescence is observed. In photovoltaic devices, recombination of the charge separation does not occur; instead the charges move toward an anode and a cathode to produce a potential difference, from which current can be produced.

Molecules with the ability to separate charges upon light initiation are useful for applications such as photocopiers, photovoltaic devices and photoreceptors. Organic photoconductors provided by the present invention are expected to be useful in such applications, due to their stability and ability to be spread into thin films. Related methods are encompassed by the invention.

Organic semiconducting materials can be used in the manufacture of photovoltaic cells that harvest light by photoinduced charge separation. To realize an efficient photovoltaic device, a large interfacial area at which effective dissociation of excitons occurs must be created; thus an electron donor material is mixed with an electron acceptor material. (Here, an exciton is a mobile combination of an electron and a hole in an excited crystal, e.g., a semiconductor.) Organic luminescent compounds as semiconductors are advantageous due to their long lifetime, efficiency, low operating voltage and low cost.

Photocopiers use a light-initiated charge separation to attract positively-charged molecules of toner powder onto a drum that is negatively charged.

The invention further provides methods employing compounds of the invention to detect metal ions. The change in the luminescence upon coordination of metal ions may be useful for detection of gunpowder residue, bomb making activity, and/or environmental contamination such as heavy metal contamination of food or soil or water, as well as for detection of sites of meteor impact and even interplanetary exploration.

The invention further provides methods employing compounds of the invention to detect acid. This aspect of the invention is expected to be useful for a variety of applications, including, without limitation, pH sensors, as well as detection of contamination, particularly environmental contamination (e.g., acidity of lakes, soil, etc.).

The invention further provides molecular switches employing compounds as described above, and methods of use thereof.

Information processing systems of current computers are based on semiconductor logic gates or switches (Tang et al., 1987). By reducing the switching elements to a molecular level, the processing capability and memory density of computers could be increased by several orders of magnitude and the power input could be decreased significantly (Leung et al., 2000). Candidates for this purpose are molecules that are capable of undergoing reversible transformations in response to chemical, electrical and/or optical stimulation, and producing readily detectable optical signals in the process. For example, the respective neutral forms of compounds of the invention (2), (3), (4), (5) and (6), when in solution, emit blue luminescence. The neutral forms can be easily converted to the non-luminescent protonated forms by the addition of acid. These can be switched back to the depronated forms by the addition of a base. Three-state molecular circuits based on (2), (3) and (4) with OH⁻, H⁺ and ultraviolet light as inputs and visible light as outputs have been established.

Example 1 to Example 5 below provide detailed descriptions of the syntheses of compounds (2), (3), (4), (5) and (6) respectively. As would be apparent to a person of ordinary skill in the art, other functionalities may be included in derivatives according to the invention. Alternatively, starting materials may be modified to include, but are not limited to, functionalities such as ether, epoxide, ester, amide or the like. Such functionalities may in some cases confer desirable physical or chemical properties, such as increased stability or luminescence.

### WORKING EXAMPLES

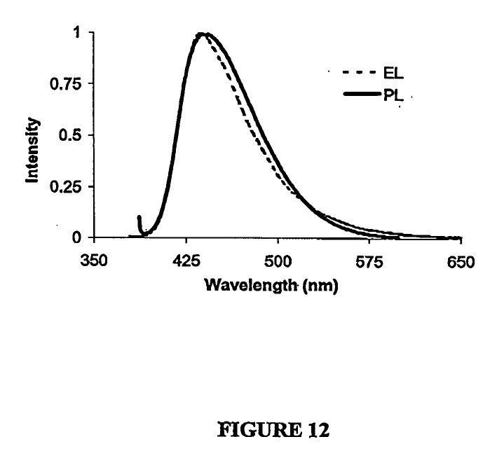

All starting materials were purchased from Aldrich Chemical Company and used without further purification. Solvents were freshly distilled over appropriate drying reagents. All experiments were carried out under a dry nitrogen atmosphere using standard Schlenk Techniques unless otherwise stated Thin Layer Chromatography was carried out on SiO₂ (silica gel F254, Whatman). Flash chromatography was carried out on silica (silica gel 60, 70-230 mesh). ¹H and ¹³C spectra were recorded on a Bruker Avance 300 spectrometer operating at 300 and 75.3 MHz respectively. Excitation and emission spectra were recorded on a Photon Technologies International QuantaMaster Model 2 spectrometer. Spin coating was done on Chemat Technology spin-coater KW-4A and vacuum deposition using a modified Edwards manual diffusion pump. The EL spectra for compound (3) (see FIG. 8) were taken using Ocean Optics HR2000 and all data involving current, voltage and luminosity using a Keithley 238 high current source measure unit. The EL spectra for compound (4) (see FIG. 12) were taken using a Photo Research—650 Spectra Colorimeter. Data collection for the X-ray crystal structural determinations were performed on a Bruker SMART CCD 1000 X-ray diffractometer with graphite-monochromated molybdenum K_{α} radiation (γ=0.71073 Å) at 298K and the data were processed on a Pentium PC using the Bruker AXS Windows NT SHELXTL software package (version 5.10). Elemental analyses were performed by Canadian Microanalytical Service Ltd., (Delta, British Columbia, Canada). Melting points were determined on a Fisher-Johns melting point apparatus. Syntheses of precursors p-(2,2′-dipyridylamino)phenylboronic acid and p-(2,2′-dipyridylamino)biphenylboronic acid were based on a modified literature method (Jia et al., 2003).

### Example 1

### 1-pyrenyl-2, 2 dipyridylamine (2)

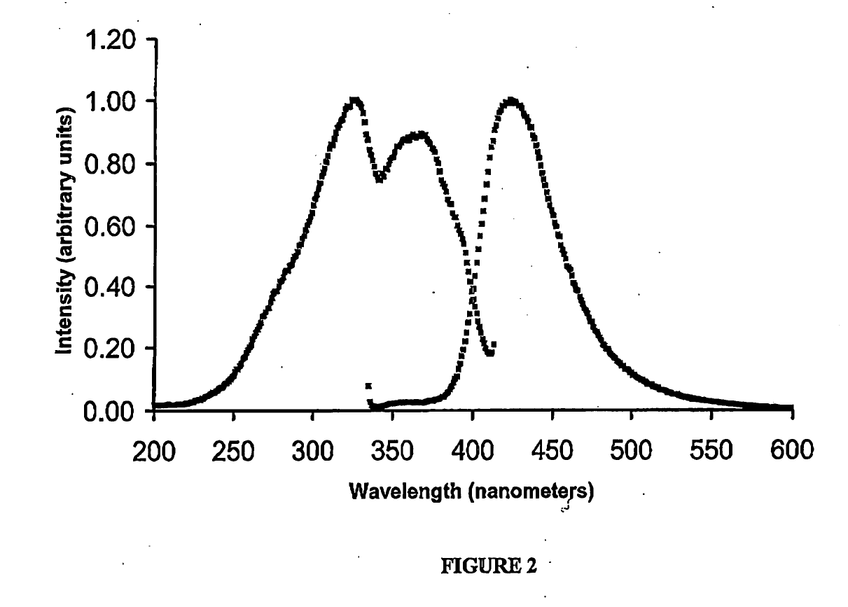

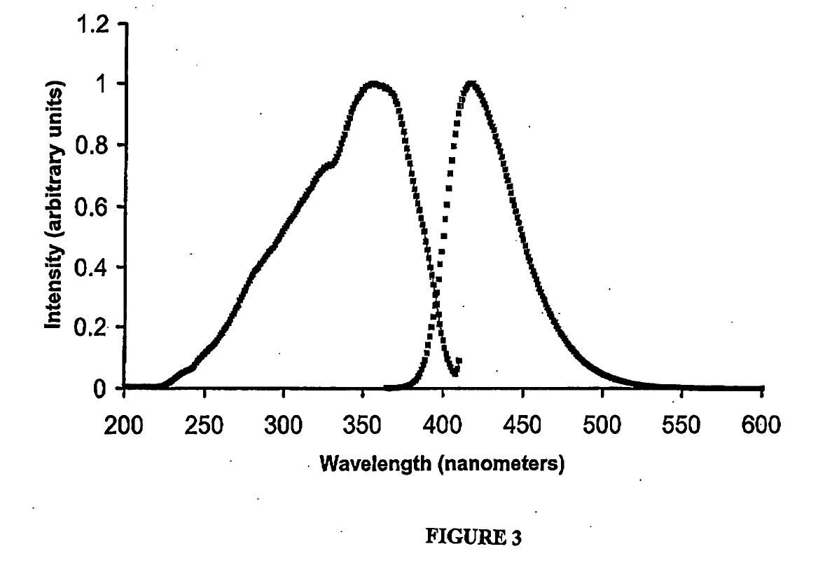

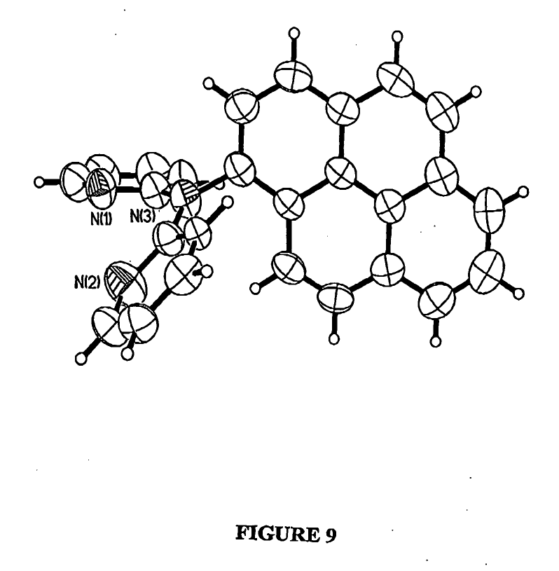

The mixture of 0.145 g, 1-bromopyrene (0.5 mmol), 0.10 g 2,2 dipyridylamine (0.58 mmol), 0.125 g CuI, 0.235 g K₃PO₄, 0.033 mL 1,2-transdiaminocyclohexane and 1 mL 1,4-dioxane was stirred at 110° C. for 24 hours. After cooling to room temperature, the mixture was extracted with dichloromethane (3×15 mL). The solvent was evaporated under reduced pressure. The residue was subjected to column chromatography on silica gel (CH₃COOEt/Hexane, 2:1) to afford a white compound (2) in 39% yield. The molecular structure of (2) was confirmed by X-ray crystallography, the structure is pictured in FIG. 9. ¹H NMR in CD₂Cl₂ at 25° C.: δ ppm=8.31(d, J=8.1, 1H), 8.27(m, 3H), 8.19 (m, 3H), 8.06(m, 3H), 7.95 (d, J=8.1, 1H), 7.56 (m, 2H), 7.08(td, d=8.4, 0.9, 2H), 6.94(ddd, J=7.2, 4.8, 1H). ¹³C NMR in CD₂Cl₂ at 25° C., 6 ppm: 159.08, 148.72, 139.16, 137.94, 131.81, 131.62, 131.12, 129.65, 128.91, 128.71, 128.20, 127.83, 126.94, 126.71, 126.53, 126.11, 125.94, 125.33, 123.45, 118.27, 116.57. Elemental analysis calculated. for C₂₆H₁₇N₃: C, 84.1, H, 4.58, 11.32. Found: C, 83.84, 4.72, 11.35. See Table 1 for λₘₐₓ values for the emission and excitation of (2) as well as its quantum efficiency. See FIG. 2 for the photoluminescence spectra of (2) as a solid, and FIG. 3 for the photoluminescence spectra of (2) as a solution. (It is of interest that intermolecular quenching does not appear to be a factor when this compound is in the solid state; rather, it is still luminescent.)

TABLE 1
Excitation, emission and photoluminescent quantum efficiency of
compounds (2), (3), (4), (5) and (6) in CH₂Cl₂ at ambient temperature.

| Compound | Excitation λₘₐₓ | Emission λₘₐₓ | Quantum Efficiency |
|---|---|---|---|
| 2 | 360 nm | 415 nm | 70% |
| 3 | 350 nm | 433 nm | 72% |
| 4 | 350 nm | 437 nm | 76% |
| 5 | 362 nm | 454 nm | >40% |
| 6 | 354 nm | 442 nm | 31% |

### Example 2

### Synthesis of 4-(1-pyrenyl)phenyl-2.2′-dipyridylamine (3)

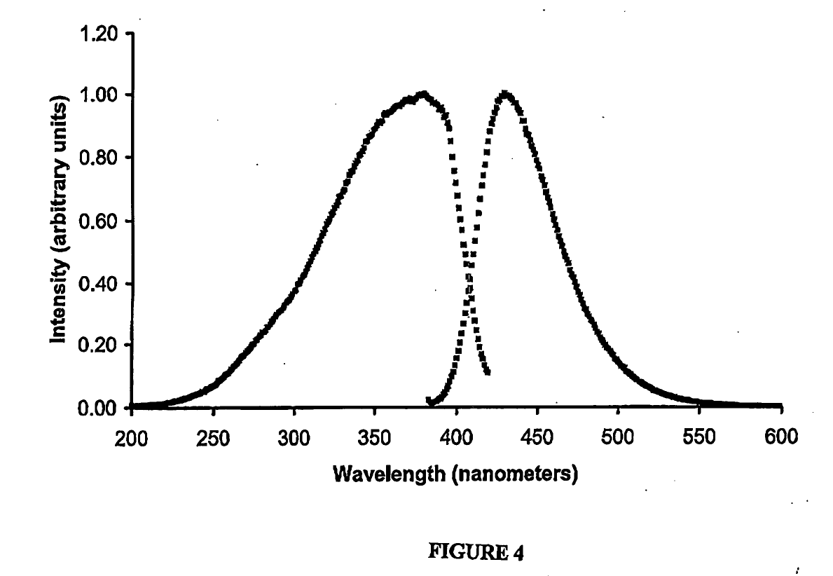

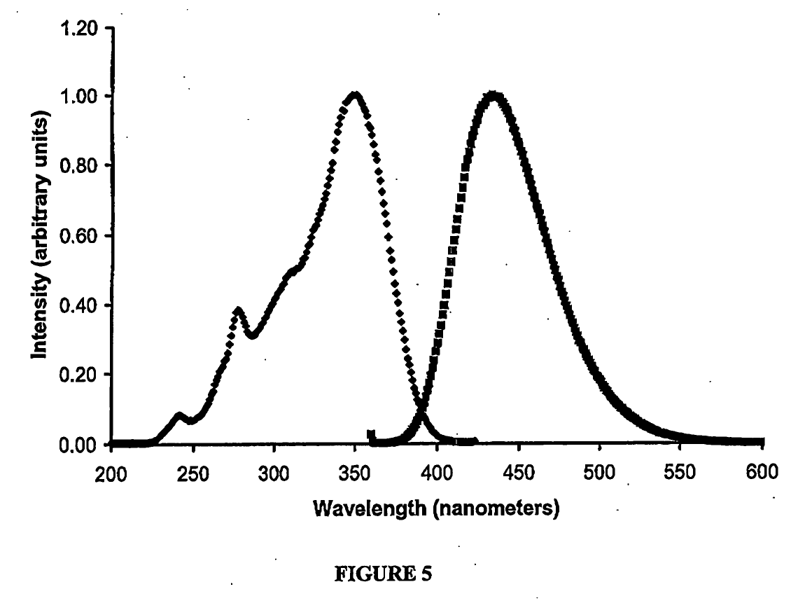

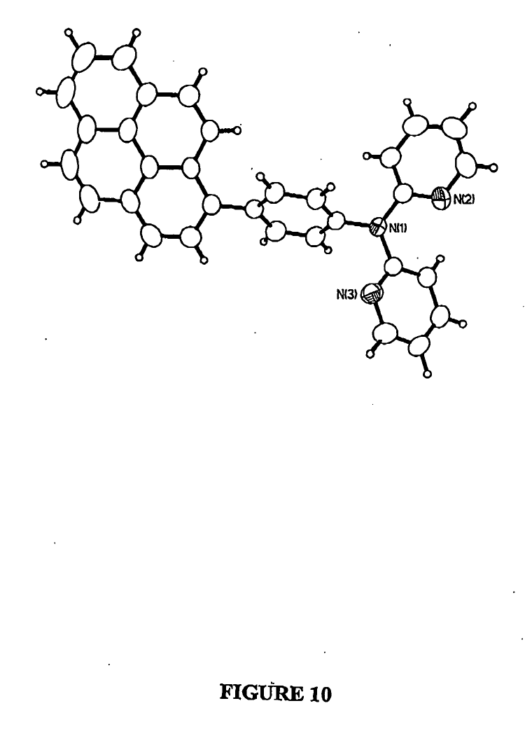

A mixture of 1-bromopyrene (0.5 g, 1.78 mmol), Pd(PPh₃)₄ (0.062 g, 0.054 mmol) and toluene(40 mL) was stirred for 10 minutes under N₂(g). A solution of p-(2,2′-dipyridylamino)phenylboronic acid (0.57 g, 1.96 mmol) in 20 mL EtOH and a solution of NaOH (0.8 g) in 20 mL H₂O were added. The resulting mixture was heated and stirred at reflux for 24 hours and was then allowed to cool to room temperature. The water layer was separated and extracted with methylene chloride (CH₂Cl₂) (3×15 mL). The combined organic layers were dried over MgSO₄, and evaporated under reduced pressure. Purification of the crude product was performed by column chromatography (THF:Hexane, 3:2) and afforded (3) as a white solid in 83% yield. The molecular structure of (3) was confirmed by X-ray crystallography, the structure is pictured in FIG. 10. ¹H NMR in CD₂Cl₂ at 25° C.: δ ppm=8.40(ddd, J=4.8, 1.8, 0.9, 2H), 8.36(d, J=9.3, 1H), 8.27(m, 3H), 8.11(m, 5H), 7.68(m, 4H), 7.40(d, J=8.4, 2H), 7.19(d, J=8.1, 2H), 7.05(ddd, J=7.2, 4.8, 0.9,2H). ¹³C NMR in CD₂Cl₂ at 25 C, δ ppm: 158.91, 149.11, 145.16, 138.56, 138.17, 137.80, 132.27, 132.18, 131.68, 131.27, 130.13, 129.09, 128.35, 128.12, 128.06, 127.58, 126.75, 125.88, 125.8, 125.63, 125.50, 125.42, 119.02, 118.63, 117.90. Elemental analysis calculated for C₃₂H₂₁N₃⅓H₂O: C, 84.77, H, 4.78, N, 9.27. Found: C, 84.89, 4.76, 9.42. See Table 1 for emission and excitation λₘₐₓ values and quantum efficiency of compound (3). See FIG. 4 for the photoluminescence spectra of (3) as a solid, and FIG. 5 for the photoluminescence spectra of (3) as a solution.

### Example 3

### Synthesis of 4-[4′-(1-pyrenyl)biphenyl]-2,2′-dipyridylamine (4)

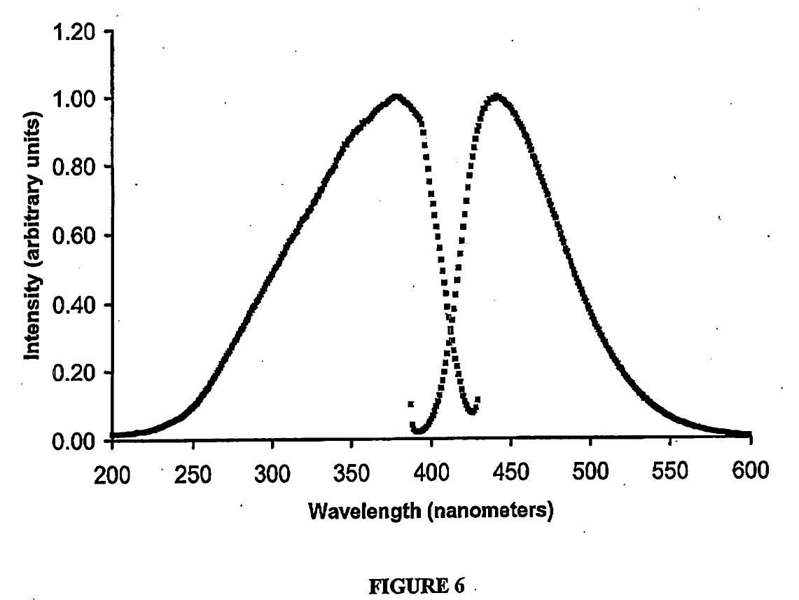

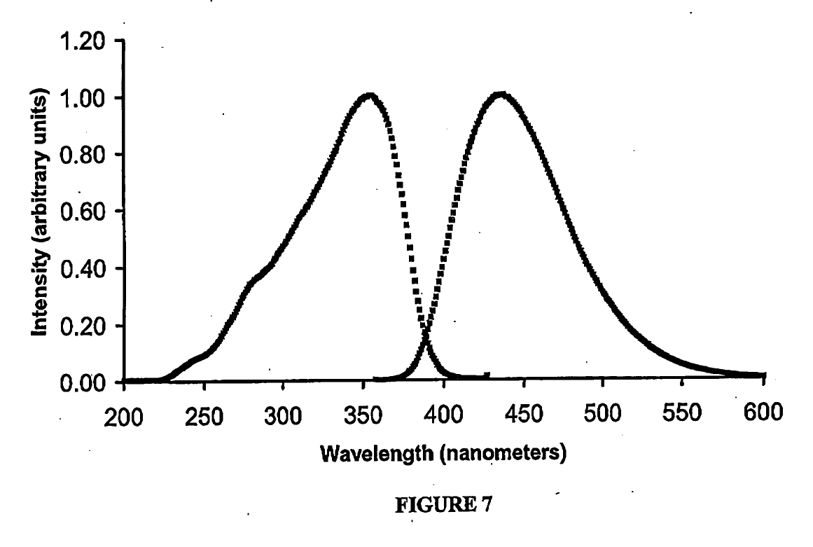

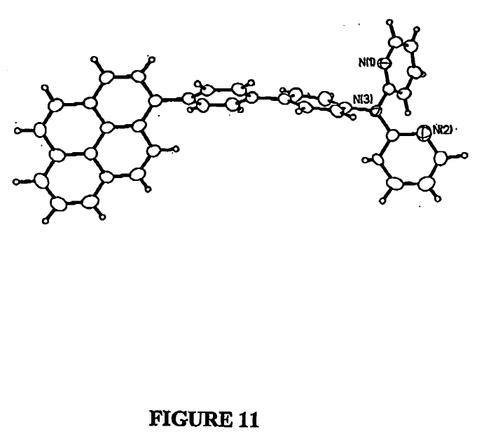

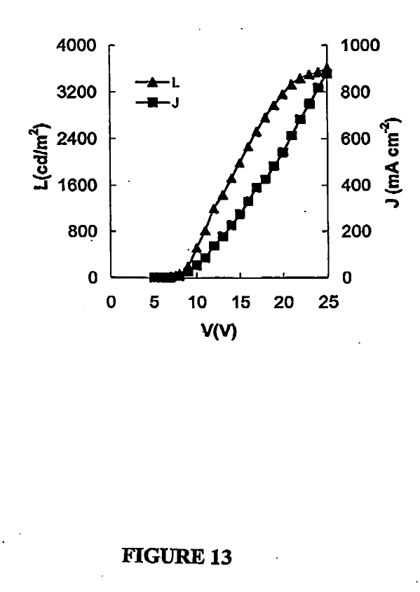

4-[4′-(1-pyrenyl)biphenyl]-2,2′-dipyridylamine was prepared by the same procedure as that used to prepare (4) above. From 1-bromopyrene (0.2983 g, 1.045 mmol), Pd(PPh₃)₄(0.036 g, 0.031 mmol), p-(2,2′-dipyridylamino)biphenylboronic acid (0.4218 g, 1.149 mmol) and NaOH(0.5 g) was obtained (4) as a white solid in 71.4% yield. The molecular structure of (4) was confirmed by X-ray crystallography, the structure is pictured in FIG. 11. ¹H NMR in CD₂Cl₂ at 25° C.: δ ppm=8.36(ddd, J=4.8, 1.8, 0.9, 2H), 8.32(d, J=1.5, 1H), 8.26, (m,3H), 8.11(m, 5H), 7.88(dd, J=1.8, 6.6, 2H), 7.78(m, 4H), 7.66(m, 2H), 7.33(dt, J=9.0, 2.4, 2H), 7.14(d, J=8.4, 2H), 7.02(ddd, J=7.2, 4.8, 0.9, 2H). ¹³C NMR in CD₂Cl₂ at 25° C., δ ppm 158.79, 149.07, 145.40, 140.74, 140.03, 138.12, 138.00, 132.66, 132.53, 132.18, 131.74, 131.67, 131.31, 130.04, 129.13, 128.71, 128.30, 128.17, 128.07, 127.54, 126.77, 125.87, 125.81, 125.52, 125.40, 118.97, 117.76, 116.22, 112.06. Elemental analysis calculated for C₃₈H₂₅N₃ C, 87.19, H, 4.78, N, 8.03. Found: C, 87.56, H, 4.94, N, 8.28. See Table 1 for emission and excitation γₘₐₓ values and quantum efficiency of compound (4). See FIG. 6 for the luminescence spectra of (4) as a solid, and FIG. 7 for the luminescence spectra of (4) as a solution. The photoluminescence spectra is overlaid with an electroluminescence spectrum in FIG. 12. Luminance-voltage and current density-voltage diagrams of (4) in a 2-layer EL device are shown in FIG. 13. FIG. 16 shows the luminance-voltage and current-voltage diagrams of (4) in a single layer EL device.

### Example 4

### Synthesis of 4-(1-pyrenyl)biphenyl-2,2′-diphenylamine (5)

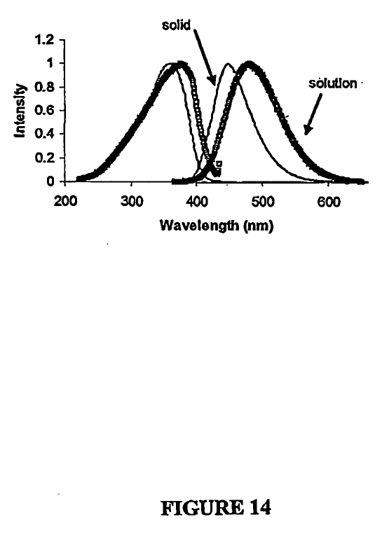

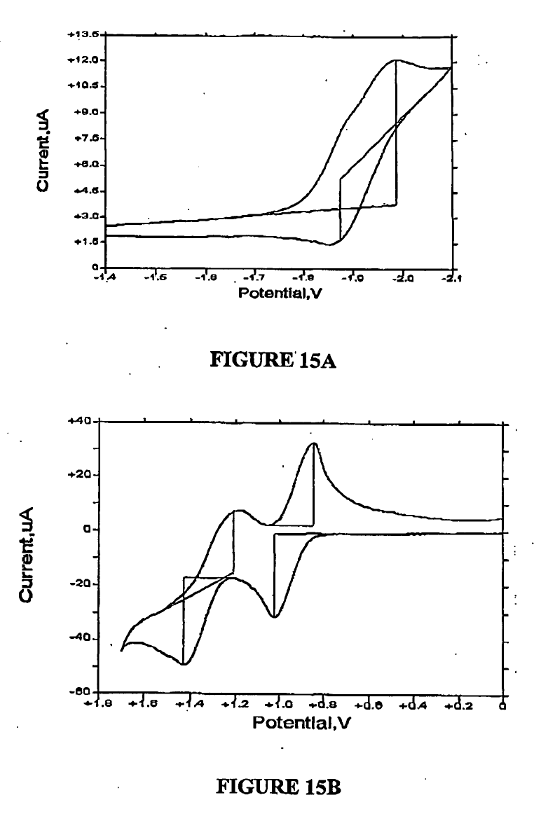

To a THF (20 ml) of 4-Iodo-4′-diphenylaminobiphenyl (Koene et al. 1998) (0.5 g, 1.12 mmol) was added a hexane solution of n-BuLi (0.77 ml, 1.23 mmol) at −78° C. After being stirred for 1 h at this temperature, B(OMe)₃ (0.2 ml, 2.5 mmol) was added. After the mixture was stirred for another 1 h at −78° C., it was warmed to ambient temperature and stirred overnight. The solution was partitioned between saturated aqueous NH₄Cl (30 mL) and CH₂Cl₂ (30 mL). The aqueous layer was extracted further with dichloromethane (2×30 mL) and the combined organic layers were dried over MgSO₄. The solvent was evaporated under vacuum to provide the boronic acid in 96% yield. A mixture of 1-bromopyrene (0.25 g, 0.89 mmol), Pd(PPh₃)₄(0.031 g, 0.027 mmol) and toluene (40 ml) was stirred for 10 min. The above boronic acid (0.36 g, 0.98 mmol) in 15 ml EtOH and Na₂CO₃(0.48 g) in 15 ml H₂O were subsequently added. The mixture was stirred and refluxed for 24 h and then allowed to cool to room temperature. The water layer was separated and extracted with CH₂Cl₂ (3×15 ml). The combined organic layers were dried over MgSO₄, and the solvents were evaporated under reduced pressure. Purification of the crude product by column chromatography (CH₂Cl₂:Hexane, 1:3) afforded (5) as colorless solid in 88% yield. ¹H NMR in CD₃Cl(δ, ppm, 25° C.): 8.29 (d, J=6.9, 1H), 8.26(d, J=5.7, 1H), 8.22 (t, J=7.8, 2H), 8.02-8.13(m, 5H), 7.80 (d, J=8.1, 2H), 7.72 (d, J=8.4, 2H), 7.63 (d, J=8.4, 2H), 7.3-7.35(m, 4H), 7.19-7.24 (m, 6H), 7.09 (t, J=7.2, 2H). See Table 1 for emission and excitation λₘₐₓ values and quantum efficiency of compound (5) and FIG. 14 for the photoluminescence spectra of (5) as a solid, and as a solution. FIG. 15A shows a cyclic voltametry diagram starting with the reduction of (5) in a mixture of CH₂Cl₂ and CH₃CN. This figure provides information about the Lowest Unoccupied Molecular Orbital (LUMO) of the molecule and indicates promising electron transport properties of the molecule. FIG. 15B shows a cyclic voltametry diagram starting with the oxidation of (5) in a mixture of CH₂Cl₂ and CH₃CN. This figure provides information about the Highest Occupied Molecular Orbital (HOMO) of the molecule and indicates promising hole transport properties of the molecule.

### Example 5

### Synthesis of 4-(1-naphthylphenylamino)-4′-(5-(8-methoxyquinolinyl))biphenyl (QNPB) (6)

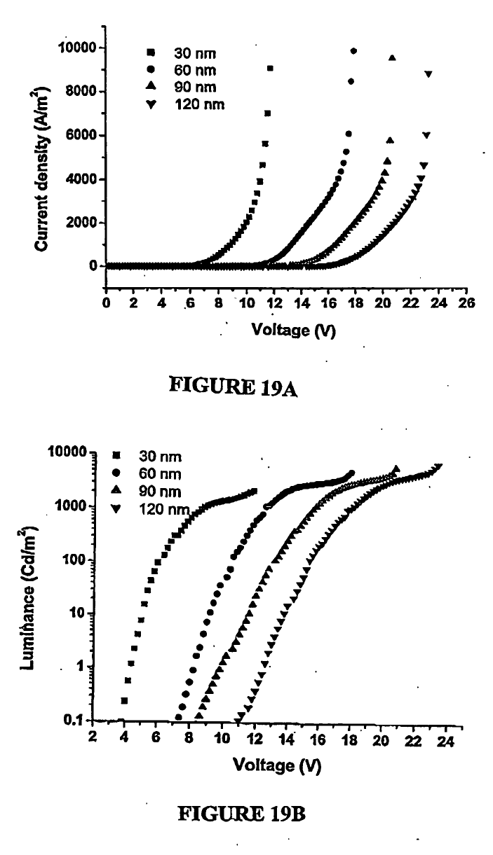

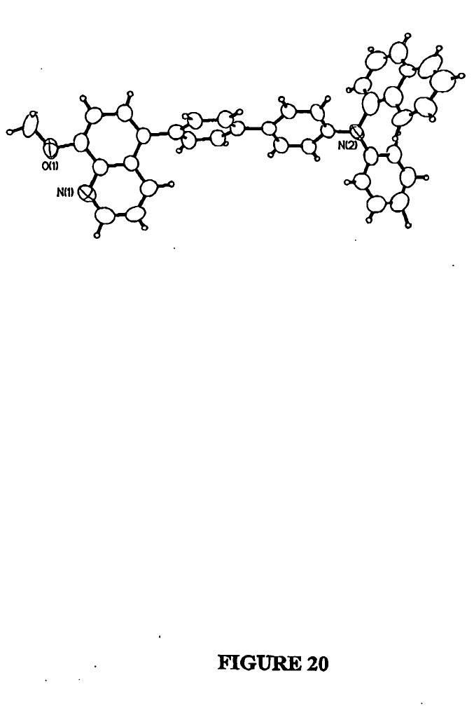

p-N-(1-naphthyl)-N-phenylamino-biphenyl-iodide (1.55 g, 3.12 mmol) was reacted with butyl lithium (2.14 mL of 1.0 M solution in hexane, 3.43 mmol) at −78° C. in 50 mL THF. Following an addition of B(i-OPr)₃ (1.1 g), a boric acid intermediate p-N-(1-naphthyl)-N-phenylamino-biphenyl-B(OH)₂ was isolated. p-N-(1-naphthyl)-N-phenylamino-biphenyl-B(OH)₂ (1.0 g, 2.4 mmol) was reacted with 5-bromo-8-methoxyquinoline (0.48 g, 2.0 mmol) in a mixture of solvents: ethanol (20 mL), toluene (35 mL) and water (15 mL) in the presence of Pd(OAc)₂ (0.026 g), PPh₃ (0.063 g), and Na₂CO₃ Product QNPB (see structure in Scheme 3) was produced in 85% yield. Elemental analysis: calc for C₃₈H₂₈N₂O, C 86.36; H, 5.30; N, 5.30. Found: C 86.40; H, 5.29; N, 5.49. The molecular structure of (6) was confirmed by X-ray crystallography; the structure is pictured in FIG. 20. ¹H NMR for QNPB (ppm, CDCl₃): 8.97 (d, 1H), 8.32 (d, 1H), 8.00 (d, 1H), 7.92 (d, 1H), 7.82 (d, 1H), 7.68 (d, 2H), 7.50 (m, 7H), 7.42 (m, 3H), 7.24 (d, 1H), 7.15 (m, 5H), 7.00 (t, 1H), 4.17 (s, 3H). See Table 1 for emission and excitation λₘₐₓ values and quantum efficiency of compound (6). A current density-voltage diagram and luminance-voltage diagram for compound (6) in a single layer EL device are shown in FIGS. 17A and 17B. The photoluminescence spectrum and the electroluminescence spectrum of compound (6) in a single layer EL device are shown in FIG. 18. A current density-voltage diagram and luminance-voltage diagram of compound (6) in a double layer EL device are shown in FIGS. 19A and 19B where (6) is the hole transport layer and Alq₃ is the emitter and electron transport layer.

### Example 6

### Preparation of a Two Layer EL Device

A two layer device was made using compound 4-(1-pyrenyl)phenyl-2,2′-dipyridylamine (3) as both a charge (electron) transport layer and an emitting layer. The configuration was: cathode, electron transport and emitting layer of compound (3) (50 nm), hole transport layer (50 nm) of NPB, anode. The emitting layer was fabricated on an ITO substrate, which was cleaned by an ultraviolet ozone cleaner immediately before use. Both the organic layers and a metal cathode of Al were deposited by conventional vapor vacuum deposition. Prior to the deposition, all the organic materials were purified via a train sublimation method (Wagner et al., 1982).

### Example 7

### Preparation of a One Layer EL Device

A one layer device was made using compound (4) as an emitting layer, an electron transport layer and a hole transport layer. The configuration was: cathode, film of compound (4) (50 nm), anode. The compound (4) layer was fabricated on an ITO substrate, which was cleaned by an ultraviolet ozone cleaner immediately before use. Both the organic layer and a metal cathode of Al were deposited by conventional vapor vacuum deposition. Prior to the deposition, all the organic materials were purified via a train sublimation method (Wagner et al., 1982). FIG. 13 shows a plot of the current vs. voltage and luminance vs voltage for this single layer device containing a 60 nm thick film of (4).

### Example 8

### Preparation of a Two Layer EL Device

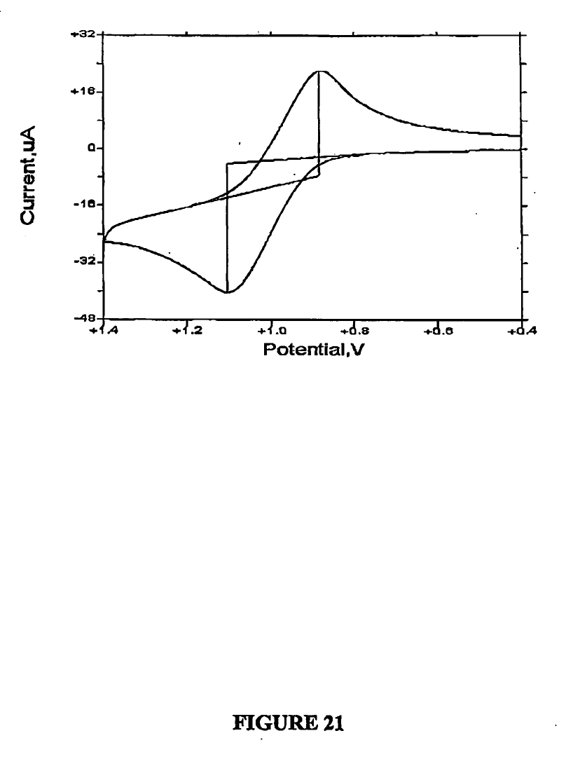

A two layer device was made using compound QNPB (6) as a hole transport layer and Alq₃ as both an electron transport layer and an emitting layer. The configuration was: cathode, electron transport and emitting layer of Alq₃, hole transport layer of QNPB (6), anode. The emitting layer was fabricated on an ITO substrate, which was cleaned by an ultraviolet ozone cleaner immediately before use. Both the organic layers and a metal cathode of Al were deposited by conventional vapor vacuum deposition. Prior to the deposition, all the organic materials were purified via a train sublimation method (Wagner et al., 1982). Several such two layer EL devices were prepared with varying thicknesses (30, 60, 90, 120 nm) of the QNPB (6) hole transport layer and constant thickness (40 nm) of the Alq₃ electron transport and emitter layer. A plot of current density vs. voltage for these devices is shown in FIG. 19A and a corresponding plot of luminance vs. voltage is shown in FIG. 19B. A cyclic voltammetry diagram starting with the oxidation of (6) in CH₂Cl₂ is shown in FIG. 21. This figure provides information about the Highest Occupied Molecular Orbital (HOMO) of the molecule and indicates promising hole transport properties of the molecule.

All scientific and patent publications cited herein are hereby incorporated in their entirety by reference.

Although this invention is described in detail with reference to preferred embodiments thereof, these embodiments are offered to illustrate but not to limit the invention. It is possible to make other embodiments that employ the principles of the invention and that fall within its spirit and scope as defined by the claims appended hereto.

### REFERENCES

Ashenhurst, J.; Brancaleon, L; Hassan, A.; Liu, W.; Schmider, H.; and Wang, S. “Blue Luminescent Organoaluminum Compounds: Al₂(CH₃)₄(7-azain)₂, Al₂(CH₃)₂(7-azain)₄, Al₂(CH₃)(OCH(CF₃)₂)₃(7-azain)₂, Al₂(μ-OCH(CF₃)₂(CH₃)(7-azain)₂((OCH(CF 3)₂)₂, Al₃(μ₃-O)(CH₃)(7-azain)₄(OCH(CF₃)₂)₂, and Al₄(μ₃—O)₂(7-azain)₆(OCH(CF₃)₂)₂ (7-azain=Deprotonated 7-Azaindole).” Organometallics (1998) 17: 3186-3195.

Ashenhurst, J.; Brancaleon, L.; Gao, S.; Liu, W.; Schmider, H.; Wang, S.; Wu, G.; and Wu, Q. G. “Blue Luminescent Organoaluminum Compounds: Al(CH₃)₂(dpa), Al₂(CH₃)₅(dpa)₂, Al₄(O)₂(CH₃)₆(dpa)₂, and Al(pfap)₃, dpa=Deprotonated Di-2-pyridylamine, pfap=Deprotonated 2-Pentafluoroanilinopyridine.” Organometallics (1998) 17: 5334-5341.

Ashenhurst, J.; Wu, G.; and Wang, S. “Syntheses, Structures, Solution, and Solid-State ²⁷Al NMR Studies of Blue Luminescent Mononuclear Aluminum Complexes: Al(7-azain)₂(7-azain-H)(CH₃), Al(7-azain)₃(7-azain-H), and Al(7-azain)(7-azain-H)(OCH(CF₃)₂)₂ (7-azain-H=7-azaindole).” J. Am. Chem. Soc. (2000)122: 2541-2547.

Gao, S.; Wu, Q.; Wu, G.; and Wang, S. “Highly Fluxional Blue Luminescent Aluminum Complexes: Al(CH₃)(7-azain-2-Ph)₂(7-azainH-2-Ph), Al₃(m₃—O)(CH₃)₃(7-azain-2-Ph)₄, and Al₃((m₃—O)(CH₃)₃(7-azain-2-CH₃)₄, 7-azain=7-azaindole anion.” Organometallics (1998)17: 4666-4674.

Hassan, A.; and Wang, S. “First blue luminescent diborate compound: B2(m-O)Et₂(7-azain)₂ (7-azain=7-azaindole anion).” Chem. Commun. (1998) 211-212.

Jia, W.-L.; Datong, S.; and Wang, S. “Blue Luminescent Three-Coordinate Organoboron Compounds with 2,2′-Dipyridylamino Functional Group.” Journal of Organic Chemistry (2003) 68: 701-705.

Koene, B.; Loy, D.; and Thompson, M. “Unsymmetrical Triaryldiamines as Thermally Stable Hole Transporting Layers for Organic Light-Emitting Devices.” Chemistry of Materials. (1998) 10(8): 2235-2250.

Leung, L. M.; Lo, W. Y.; So, S. K.; Lee, K. M.; and Choi, W. K. J. “A High-Efficiency Blue Emitter for Small Molecule-Based Organic Light-Emitting Diode.” J. Am. Chem. Soc. (2000) 122: 5640-5641.

Liu, S.; Wu, Q.; Schmider, H. L.; Aziz, H.; Hu, N.; Popovic, Z.; and Wang, S. “Syntheses, Structures, and Electroluminescence of New Blue/Green Luminescent Chelate Compounds: Zn(2-py-in)₂(THF), BPh₂(2-py-in), Be(2-py-in)₂, and BPh₂(2-py-aza), 2-py-in=2-(2-pyridyl)indole, 2-py-aza=2-(2-pyridyl)-7-azaindole.” J. Am. Chem. Soc. (2000)122: 3671-3678.

Pang, J.; Marcotte, E. J.-P.; Seward, C.; Brown, R. S.; and Wang, S. “A blue luminescent star-shaped Zn¹¹ complex that can detect benzene.” Angew. Chem. Int. Ed. (2001)40: 4021-4042.

Rack, P. D.; Naman, A.; Holloway, P. H.; Sun, S.-S.; and Tuenge, R. T. “Materials used in electroluminescent displays.” MRS Bulletin (1996) 21(3): 49-58.

Shirota, Y. “Organic materials for electronic and optoelectronic devices.” Journal of Materials Chemistry. (2000) 10(1): 1-25.

Tang, C. W.; and Van Slyke, S. A. “Organic electroluminescent diodes.” Applied Physics Letters (1987) 51(12): 913-915.

Van Slyke, S. A.; Chen, C. H.; and Tang, C. W. “Organic electroluminescent devices with improved stability.” Applied Physics Letters (1996) 69(15): 2160-2162.

Wagner, H. J.; Loutfy, R. O.; and Hsiao, C. K. “Purification and characterization of phthalocyanines.” Journal of Materials Science (1982) 17(10): 2781-2791.

Wang, S.; Liu, A.; and Hassan, A. “Luminescent Compounds and Methods of Making and Using Same.” U.S. Pat. No. 6,312,835, issued on Nov. 6, 2001.

Wang, S.; Liu, A.; and Hassan, A. “Luminescent Compounds and Methods of Making and Using Same.” U.S. Pat. No. 6,500,569, issued Dec. 31, 2002.

Wu, Q.; Lavigne, J. A.; Tao, Y.; D'Iorio, M.; and Wang, S. “Novel Blue Luminescent/Electroluminescent 7-Azaindole Derivatives: 1,3-Di(N-7-azaindolyl)benzene, 1-Bromo-3,5-Di(N-7-azaindolyl)benzene, 1,3,5-Tri(N-7-azaindolyl)benzene, and 4,4′-Di(N-7-azaindolyl)biphenyl.” Chemistry of Materials (2001) 13(1): 71-77.

Yamazaki, S. “Chromium(VI) oxide-catalyzed oxidation of arenes with periodic acid.” Tetrahedron Letters (2001) 42(19): 3355-3357.

Yang, W.; Chen, L.; and Wang, S. “Syntheses, Structures, and Luminescence of Novel Lanthamide Complexes of Tripyridylamine, N,N,N′,N′-Tetra(2-pyridyl)-1,4-phenylenediamine, and N,N,N′,N′-Tetra(2-pyridyl)-biphenyl-4,4′-diamine.” Inorganic Chemistry (2001) 40: 507-515.

We claim:

1. A compound having a general formula (1A): 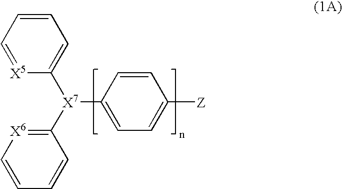
where X⁵, X⁶ and X⁷ are each independently selected from the group consisting of carbon and nitrogen;
n is a number from 0-2;
Z is a substituted or unsubstituted aryl moiety selected from the group consisting of phenyl, biphenyl, naphthyl, anthryl, phenanthryl, pyrenyl, pyridyl, bipyridyl, indyl, and quinolinyl; and
wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

2. A compound having a general formula (1B): 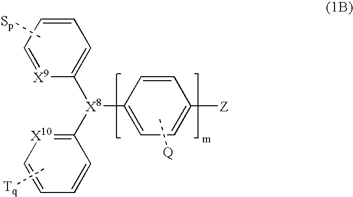
where X⁸, X⁹ and X¹⁰ are each independently selected from the group consisting of a substituted or unsubstituted carbon, an unsubstituted nitrogen and a substituted or unsubstituted silicon;
m is a number from 0-10;
Q, S and T are the same or different and are selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic;
p and q are the same or different and are a number between 0-5;
r is a number between 0-4;
Z is a substituted or unsubstituted aryl moiety selected from the group consisting of phenyl, biphenyl, naphthyl, anthryl, phenanthryl, pyrenyl, pyridyl, bipyridyl, indyl, and quinolinyl;
wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

3. A compound having a general formula (1C): 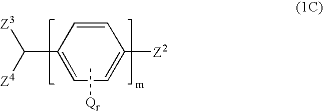
where
Z², Z³ and Z⁴ are each independently a substituted or unsubstituted aryl moiety selected from the group consisting of phenyl, biphenyl, naphthyl, anthryl, phenanthryl, pyrenyl, pyridyl, bipyridyl, indyl, and quinolinyl;
m is a number from 0-10;
Q is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic;
r is a number between 0 and 4;
wherein a said substituent is selected from the group consisting of an aryl group, an alkoxy group, a hydroxy group, a halo group, an amino group, a nitro group, a nitrile group, —CF₃ and an aliphatic group having 1-24 carbon atoms which may be straight, branched or cyclic.

4. A compound as claimed in claim 1, wherein said compound is photoluminescent or electroluminescent.

5. A compound as claimed in claim 2, wherein said compound is photoluminescent or electroluminescent.

6. A compound as claimed in claim 3, wherein said compound is photoluminescent or electroluminescent.

7. A compound as claimed in claim 1, 2 or 3 wherein said compound is a hole transporter.

8. A compound as claimed in claim 1, wherein X⁵, X⁶ and X⁷ are each independently selected from the group consisting of a substituted carbon, an unsubstituted carbon and an unsubstituted nitrogen.

9. A compound as claimed in claim 1, wherein at least one of X⁵, X⁶ and X⁷ is nitrogen.

10. A compound as claimed in claim 1, wherein X⁵, X⁶ and X⁷ are nitrogen.

11. A method of synthesizing a compound as claimed in claim 1, comprising a step selected from the group consisting of:
1-bromopyrenyl+2,2′-dipyridylamine+CuI+K₃PO_{4+1,2}-transdiaminocyclohexane+1,4-dioxane [symbol] 1-pyrenyl-2,2′-dipyridylamine (2);
Pd(PPh₃)₄₊₁-bromopyrene+p-(2,2′-dipyridylamino)phenyl boronic acid [symbol] 4-(1-pyrenyl)phenyl-2,2′-dipyridylamine(3);
Pd(PPh₃)₄₊₁-bromopyrene+p-(2,2′-dipyridylamino)biphenylboronic acid [symbol] 4-[4′-(1-pyrenyl)biphenyl]-2,2′-dipyridylamine(4);
4-iodo-4′-diphenylaminobiphenyl+B(OCH₃)₃+N-BuLi [symbol] 4-(1-pyrenyl)biphenyl-2,2′-diphenylamine (5); and
p-N-(1-naphthyl)-N-phenylamino-biphenyl-iodide+B(i-OPr)₃+N-BuLi [symbol] p-N-(1-naphthyl)-N-phenylamino-biphenyl-B(OH)₂₊₅-bromo-8-methoxyquinoline+Pd(OAc)₂+PPh₃+Na₂CO₃ [symbol] QNPB (6).

12. A compound as claimed in claim 2,
wherein
X⁸ is selected from the group consisting of a substituted or unsubstituted carbon, an unsubstituted nitrogen and a substituted or unsubstituted silicon;
X⁹ and X¹⁰ are each independently selected from the group consisting of a substituted or unsubstituted carbon and an unsubstituted nitrogen; and
m is a number from 0 to 4.

13. A compound as claimed in claim 2,
wherein
X⁸ is nitrogen;
X⁹ and X¹⁰ are each independently selected from the group consisting of a substituted or unsubstituted carbon and an unsubstituted nitrogen; and
m is a number from 1 to 4.

14. A method of synthesizing a compound as claimed in claim 2, comprising a step selected from the group consisting of:
1-bromopyrenyl+2,2′-dipyridylamine+CuI+K₃PO_{4+1,2}-transdiaminocyclohexane+1,4-dioxane [symbol] 1-pyrenyl-2,2′-dipyridylamine (2);
Pd(PPh₃)₄+1-bromopyrene+p-(2,2′-dipyridylamino)phenyl boronic acid [symbol] 4-(1-pyrenyl)phenyl-2,2′-dipyridylamine(3);
Pd(PPh₃)₄₊₁-bromopyrene+p-(2,2′-dipyridylamino)biphenylboronic acid [symbol] 4-[4′-(1-pyrenyl)biphenyl]-2,2′-dipyridylamine(4); and
4-iodo-4′-diphenylaminobiphenyl+B(OCH₃)₃+N-BuLi [symbol] 4-(1-pyrenyl)biphenyl-2,2′-diphenylamine (5).

15. A method of synthesizing a compound as claimed in claim 3, comprising a step selected from the group consisting of:
p-N-(1-naphthyl)-N-phenylamino-biphenyl-iodide+B(i-OPr)₃+N-BuLi [symbol] p-N-(1-naphthyl)-N-phenylamino-biphenyl-B(OH)₂₊₅-bromo-8-methoxyquinoline+Pd(OAc)₂+PPh₃+Na₂CO₃ [symbol] QNPB (6).

16. A photoluminescent or electroluminescent compound having a formula selected from the group consisting of 1-pyrenyl-2,2′-dipyridylamine (2), 4-(1-pyrenyl)phenyl-2,2′-dipyridylamine (3), 4-[4′-(1-pyrenyl)biphenyl]-2,2′-dipyridylamine (4), 4-(1-pyrenyl)biphenyl-2,2′-diphenylamine (5) and QNPB (6).

17. A composition comprising a compound as claimed in claim 1, an organic polymer and a solvent.

18. A composition comprising a compound as claimed in claim 2, an organic polymer and a solvent.

19. A composition comprising a compound as claimed in claim 3, an organic polymer and a solvent.

20. A photoluminescent product or an electroluminescent product comprising a compound as claimed in claim 1, 2, 3 or 16.

21. The product of claim 20 which is a flat panel display device.

22. The product of claim 20 which is a luminescent probe.

23. A method of producing electroluminescence, comprising the steps of: providing an electroluminescent compound as claimed in claim 4, 5, or 6 and applying a voltage across said compound so that said compound electroluminesces.

24. An electroluminescent device for use with an applied voltage, comprising:
a first electrode,
an emitter which is an electroluminescent compound as claimed in claim 4, 5, or 6, and
a second, transparent electrode,
wherein voltage is applied to the two electrodes to produce an electric field across the emitter so that the emitter electroluminesces.

25. An electroluminescent device for use with an applied voltage, comprising:
a first electrode,
a second, transparent electrode,
an electron transport layer adjacent the first electrode,
a hole transport layer adjacent the second electrode, and
an emitter which is an electroluminescent compound as claimed in claim 4, 5, or 6 interposed between the electron transport layer and the hole transport layer,
wherein voltage is applied to the two electrodes to produce an electric field across the emitter so that the emitter electroluminesces.

26. An electroluminescent device for use with an applied voltage, comprising:
a first electrode,
a second, transparent electrode,
a layer which is both an emitter and an electron transporter which is an electroluminescent compound as claimed in claim 4, 5, or 6 and which is located adjacent the first electrode, and
a hole transport layer which is interposed between the emitter and electron transport layer and the second electrode,
wherein voltage is applied to the two electrodes to produce an electric field so that the emitter electroluminesces.

27. An electroluminescent device for use with an applied voltage, comprising:
a first electrode,
a second, transparent electrode,
a layer which is all of an emitter, an electron transporter and a hole transporter which is an electroluminescent compound as claimed in claim 4, 5, or 6 and which is interposed between the first and the second electrode,
wherein voltage is applied to the two electrodes to produce an electric field so that the emitter electroluminesces.

28. An electroluminescent device for use with an applied voltage, comprising:
a first electrode,
a second, transparent electrode,
an electron transport layer which is a compound as claimed in claim 1, 2, or 3 and which is located adjacent the first electrode,
a hole transport layer adjacent the second electrode, and
an emitter which is interposed between the electron transport layer and the hole transport layer,
wherein voltage is applied to the two electrodes to produce an electric field so that the emitter electroluminesces.

29. An electroluminescent device for use with an applied voltage, comprising:
a first electrode,
a second, transparent electrode,
an electron transport layer which is located adjacent the first electrode,
a hole transport layer which is a compound as claimed in claim 1, 2, or 3 and which is located adjacent the second electrode, and
an emitter which is interposed between the electron transport layer and the hole transport layer,
wherein voltage is applied to the two electrodes to produce an electric field so that the emitter electroluminesces.

30. An electroluminescent device for use with an applied voltage, comprising:
a first electrode,
a second, transparent electrode,
a layer which is both an electron transporter and an emitter which is located adjacent the first electrode, and
a hole transport layer which is a compound as claimed in claim 1, 2, or 3 and which is interposed between the electron transport layer and the second electrode,
wherein voltage is applied to the two electrodes to produce an electric field so that the emitter electroluminesces.

31. An electroluminescent device for use with an applied voltage, comprising:
a first electrode,
a second, transparent electrode,
an electron transport layer which is located adjacent the first electrode, and
a layer which is both an emitter and a hole transporter which is a compound as claimed in claim 1, 2, or 3 and which is interposed between the electron transport layer and the second electrode,
wherein voltage is applied to the two electrodes to produce an electric field so that the emitter electroluminesces.

32. A method of detecting metal ions comprising the steps of: providing a photoluminescent compound as claimed in claim 4, 5, or 6 and detecting photoluminescence of said compound, wherein contact with a metal ion quenches said photoluminescence of said compound.

33. The method of claim 32, wherein said metal ions are selected from the group consisting of Zn²⁺, Cu²⁺ Ni²⁺ Cd²⁺ Hg²⁺ and Ag⁺.

34. A method of detecting acid comprising the steps of: providing a photoluminescent compound as claimed in claim 4, 5, or 6 and detecting photoluminescence of said compound, wherein protonation of said compound changes the state of said compound's photoluminescence.

35. A method of harvesting photons comprising the steps of: providing a compound as claimed in claim 1, and providing light such that photons strike said compound and charge separation occurs in said compound.

36. A method of harvesting photons comprising the steps of: providing a compound as claimed in claim 2, and providing light such that photons strike said compound and charge separation occurs in said compound.

37. A method of harvesting photons comprising the steps of: providing a compound as claimed in claim 3, and providing light such that photons strike said compound and charge separation occurs in said compound.

38. The method as claimed in claim 35, 36 or 37, wherein said separated charges recombine and photons are released.

39. The method as claimed in claim 35, 36 or 37, wherein said separated charges migrate to respective electrodes to produce a potential difference.

40. A method of separating charges comprising the steps of: providing a compound as claimed in claim 1 and providing light such that photons strike said compound and charge separation occurs in said compound.

41. A method of separating charges comprising the steps of: providing a compound as claimed in claim 2 and providing light such that photons strike said compound and charge separation occurs in said compound.

42. A method of separating charges comprising the steps of: providing a compound as claimed in claim 3 and providing light such that photons strike said compound and charge separation occurs in said compound.

43. The method of claim 40, 41 or 42, wherein said separated charges recombine and photons are released.

44. The method of claim 40, 41 or 42, wherein said separated charges migrate to respective electrodes to produce a potential difference.

45. A photocopier employing the method of claim 35, 36, 37, 40, 41 or 42.

46. A photovoltaic device employing the method of claim 35, 36, 37, 40, 41 or 42.

47. A photoreceptor employing the method of claim 35, 36, 37, 40, 41 or 42.

48. A solar cell employing the method of claim 35, 36, 37, 40, 41 or 42.

49. A semiconductor employing the method of claim 35, 36, 37, 40, 41 or 42.

50. A molecular switch comprising a compound as claimed in claim 4, 5 or 6 that is capable of existing in more than one luminescent state, wherein acid, base, and/or incident light produces a change in the luminescent state of said compound.

51. A circuit comprising a molecular switch as claimed in claim 48.
